(19) United States
(12) Patent Application Publication
(10) Pub. No.: US 2006/0199917 A1
(43) Pub. Date: Sep. 7, 2006

(54) Thermoplastic elastomer and thermoplastic elastomer composition

(76) Inventor: Keisuke Chino, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/553,420

(22) PCT Filed: Nov. 5, 2004
(86) PCT No.: PCT/JP04/16785

§ 371 Date: Oct. 17, 2005

(30) Foreign Application Priority Data
Nov. 6, 2003 (JP) 2003-376827
Jan. 23, 2004 (JP) 2004-016272
Aug. 30, 2004 (JP) 2004-249691
Aug. 30, 2004 (JP) 2004-249882

(51) Int. Cl. C08F 8/30

(52) U.S. Cl. 525/374; 524/493; 525/375

(57) ABSTRACT

The objects of the present invention are to provide thermoplastic elastomers which retain an excellent recyclability while also having an excellent mechanical strength, particularly an excellent compression set, and to provide thermoplastic elastomer compositions which include such thermoplastic elastomers. These objects are achieved by the thermoplastic elastomers and thermoplastic elastomer compositions described below. One thermoplastic elastomer of the present invention is a hydrogen-bondable thermoplastic elastomer composed of an elastomeric polymer having, on side chains, carbonyl-containing groups and imidazole rings, which rings bear a hydrogen atom on a nitrogen atom and also bear an alkyl, aralkyl or aryl group. Another thermoplastic elastomer of the present invention is a thermoplastic polymer having side chains of a given structural formula that contain a carbonyl group and an imino group. The inventive thermoplastic elastomer compositions are compositions which include such thermoplastic elastomers.

### TECHNICAL FIELD

The present invention relates to thermoplastic elastomers and thermoplastic elastomer compositions. More particularly, the present invention relates to thermoplastic elastomers having the property of being able to repeatedly undergo crosslink formation and crosslink dissociation with changes in temperature (such property is sometimes referred to below as “recyclability”), and to thermoplastic elastomer composition containing such thermoplastic elastomers.

### BACKGROUND ART

For a variety of reasons that include protecting the environment and conserving natural resources, there is a desire today that spent materials be re-used. Crosslinked rubbers (vulcanized rubbers) have a stable three-dimensional network structure in which a polymeric substance material and a crosslinking agent (vulcanizing agent) are covalently bonded, and thus exhibit a very high strength. However, because they are crosslinked by strong covalent bonds, such rubbers are difficult to remold. On the other hand, thermoplastic elastomers make use of physical crosslinking, and so can easily be molded and processed by heating and melting without requiring a complicated vulcanization/molding step such as preforming.

Typical examples of such thermoplastic elastomers are known to include thermoplastic elastomers which have a resin component and a rubber component. At room temperatures, the microcrystalline resin component exists as hard segments that serve as crosslink points in the three-dimensional network structure, preventing plastic deformation of the rubber component (soft segments). When the temperature rises, the thermoplastic elastomer undergoes plastic deformation due to softening or melting of the resin component. However, because such thermoplastic elastomers contain a resin component, the rubber elasticity tends to be low. Accordingly, there exists a desire for materials which can be conferred with thermoplasticity without including a resin component.

To address this challenge, the inventor earlier suggested that hydrogen-bondable thermoplastic elastomers composed of an elastomeric polymer having carbonyl-containing groups and heterocyclic amine-containing groups on side chains are able, using hydrogen bonds, to repeatedly undergo crosslink formation and dissociation with changes in temperature (see JP 2000-169527 A).

Thermoplastic elastomers endowed with such a property have significant industrial potential, are of considerable value in protecting the environment, and can also achieve a high tensile strength. In addition, they hold much promise as highly recyclable materials which undergo no change in physical properties even with repeated crosslink formation and dissociation.

### DISCLOSURE OF THE INVENTION

However, the thermoplastic elastomers described in the foregoing patent application publication, even when fillers and the like are compounded therewith to form compositions, sometimes lack sufficient mechanical strength, particularly compression set upon release after being compressed for a given length of time.

It is therefore an object of the invention to provide thermoplastic elastomers which maintain an excellent recyclability while also having an excellent mechanical strength, especially an excellent compression set. Another object of the invention is to provide thermoplastic elastomer compositions which include such thermoplastic elastomers.

The inventor has conducted extensive investigations in order to achieve these objects. As a result, the inventor has learned that to enhance the mechanical strength, it is advantageous for a hydrogen atom to be present on a nitrogen atom of the nitrogen heterocycles introduced onto side chains of the elastomeric polymer making up the thermoplastic elastomer. However, because of the possibility that this hydrogen atom will form a crosslink with another functional groups, gelation tends to occur. To maintain the recyclability of the thermoplastic elastomer, it is therefore advantageous to include also an alkyl group, aralkyl group or aryl group on the nitrogen heterocycle so as to suppress hydrogen interactions by steric hindrance.

Based on this finding, the inventor has discovered nitrogen heterocycles which, by suppressing gelation, are able to ensure excellent recyclability and can also improve the mechanical strength, especially the compression set, of thermoplastic elastomers. This discovery led to the present invention.

In addition, as a result of extensive investigations, the inventor has also found that thermoplastic elastomers with side chains that include a specific structure maintain a good recyclability, while having also excellent physical properties such as mechanical strength and compression set. This discovery also led to the present invention.

Accordingly, this invention provides the thermoplastic elastomers, thermoplastic elastomer compositions containing such thermoplastic elastomers, and methods of preparing them described below as (a) to (p).

(a) A thermoplastic elastomer consists of an elastomeric polymer having, on side chains, carbonyl-bearing groups and imidazole rings, which rings bear a hydrogen atom on a nitrogen atom and also bear an alkyl, aralkyl or aryl group.

Here, the alkyl, aralkyl or aryl group is preferably bonded at the 2, 4 or 5 position on the imidazole ring. Bonding at the 2 position is especially preferred because effective steric blocking of the hydrogen atom on the nitrogen atom is possible.

The bond positions (1 to n positions) used below are based on IUPAC nomenclature.

(b) The thermoplastic elastomer according to (a) above, wherein the side chains have a structure of formula (1) or (2) below.

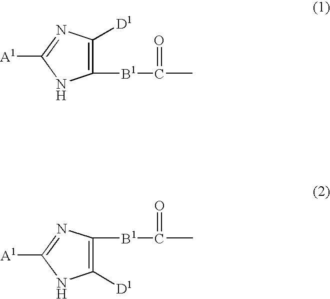

In these formulas, A¹ is an alkyl group of 1 to 20 carbons, an aralkyl group of 7 to 20 carbons or an aryl group of 6 to 20 carbons; B¹ is a single bond, an oxygen, nitrogen or sulfur atom, or an organic group which may include these atoms; and D¹ is a hydrogen atom, an alkyl group of 1 to 20 carbons, an aralkyl group of 7 to 20 carbons, or an aryl group of 60 to 20 carbons.

(c) The thermoplastic elastomer according to (a) or (b) above, wherein the side chains have a structure of any one of formulas (3) to (6) below which is bonded to a main chain at α or β position.

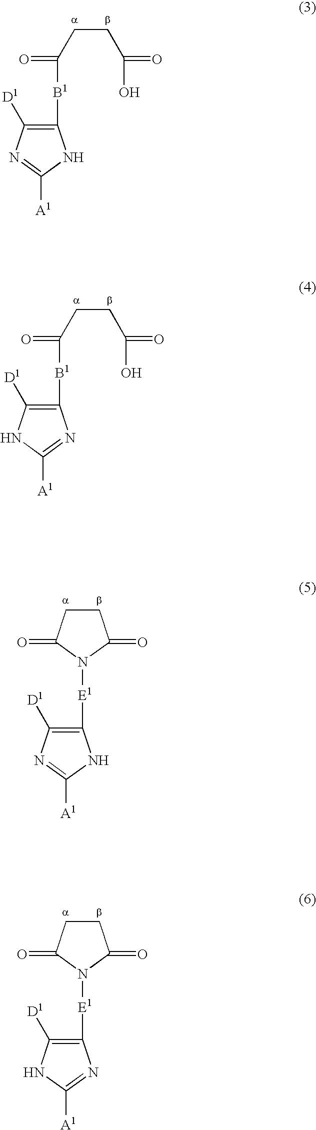

In these formulas, A¹ is an alkyl group of 1 to 20 carbons, an aralkyl group of 7 to 20 carbons or an aryl group of 6 to 20 carbons; B¹ and E¹ are each independently a single bond, an oxygen, nitrogen or sulfur atom, or an organic group which may include these atoms; and D¹ is a hydrogen atom, an alkyl group of 1 to 20 carbons, an aralkyl group of 7 to 20 carbons or an aryl group of 6 to 20 carbons.

(d) A thermoplastic elastomer having side chains which include a structure of formula (7) below.

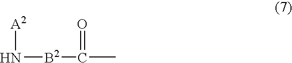

In this formula, A² is an alkyl group of 1 to 30 carbons, an aralkyl group of 7 to 20 carbons or an aryl group of 6 to 20 carbons; and B² is a single bond, an oxygen atom, an amino group NR′ (R′ being a hydrogen atom or an alkyl group of 1 to 10 carbons), a sulfur atom, or an organic group which may include these atoms or group.

(e) The thermoplastic elastomer according to (d) above, wherein the side chains which include the structure of formula (7) have a structure of formula (8) or (9) below which bonds to a main chain at α or β position.

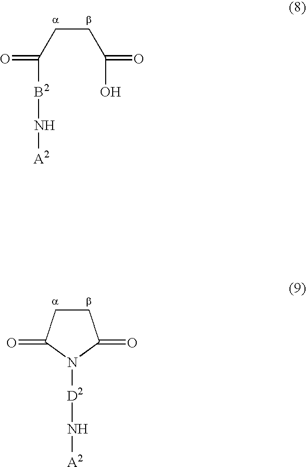

In these formulas, A² is an alkyl group of 1 to 30 carbons, an aralkyl group of 7 to 20 carbons, or an aryl group of 6 to 20 carbons; B² and D² are each independently a single bond, an oxygen atom, an amino group NR′ (R′ being a hydrogen atom or an alkyl group of 1 to 10 carbons), a sulfur atom, or an organic group which may include these atoms or group.

(f) The thermoplastic elastomer according to (d) or (e) above which also has a nitrogen heterocycle-containing side chains.

(g) The thermoplastic elastomer according to (f) above, wherein the nitrogen heterocycle-containing side chains include a structure of formula (10) below.

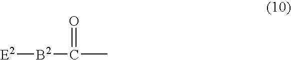

In the formula, E² is a nitrogen heterocycle; and B² is a single bond, an oxygen atom, an amino group NR′ (R′ being a hydrogen atom or an alkyl group of 1 to 10 carbons), a sulfur atom, or an organic group which may include these atoms or group.

(h) The thermoplastic elastomer according to (g) above, wherein the nitrogen heterocycle-containing side chain have a structure of formula (11) or (12) below which bonds to a main chain at α or β position.

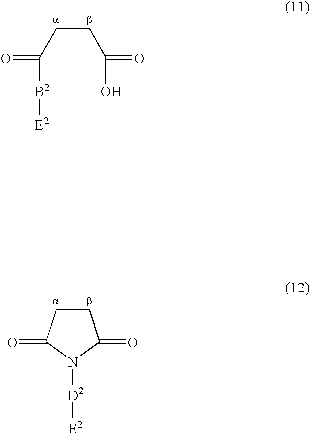

In these formulas, E² is a nitrogen heterocycle; and B² and D² are each independently a single bond, an oxygen atom, an amino group NR′ (R′ being a hydrogen atom or an alkyl group of 1 to 10 carbons), a sulfur atom, or an organic group which may include these atoms or group.

(i) The thermoplastic elastomer according to any one of (f) to (h) above, wherein the nitrogen heterocycle is a five- or six-membered ring.

(j) The thermoplastic elastomer according to (i) above, wherein the nitrogen heterocycle is a triazole ring, a thiadiazole ring, a pyridine ring or an imidazole ring.

(k) The thermoplastic elastomer according to (g) above, wherein the nitrogen heterocycle-containing side chains include a structure of formula (13), (14) or (15) below.

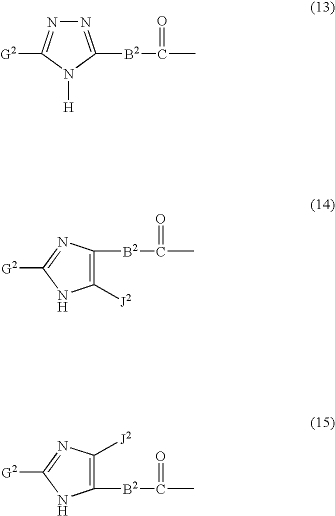

In the formulas, B² is a single bond, an oxygen atom, an amino group NR′ (R′ being a hydrogen atom or an alkyl group of 1 to 10 carbons), a sulfur atom, or an organic group which may include these atoms or group; and G² and J² are each independently a hydrogen atom, an alkyl group of 1 to 30 carbons, an aralkyl group of 7 to 20 carbons, or an aryl group of 6 to 20 carbons.

(l) The thermoplastic elastomer according to (k) above, wherein the nitrogen heterocycle-containing side chains have a structure of formula (16) or (17) or any one of formulas (18) to (21) below which bonds to a main chain at α or β position.

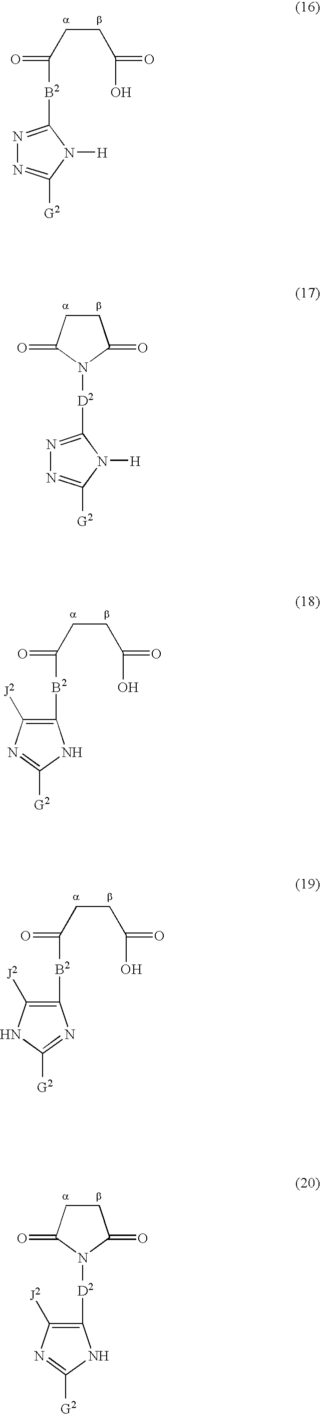

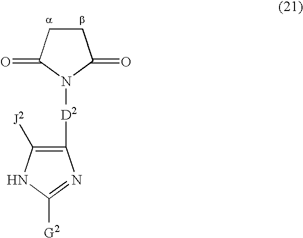

In these formulas, B² and D² are each independently a single bond, an oxygen atom, an amino group NR′ (R′ being a hydrogen atom or an alkyl group of 1 to 10 carbons), a sulfur atom, or an organic group which may include these atoms or group; and G² and J² are each independently a hydrogen atom, an alkyl group of 1 to 30 carbons, an aralkyl group of 7 to 20 carbons, or an aryl group of 6 to 20 carbons.

(m) A method of preparing the thermoplastic elastomer according to any one of (d) to (l) above, which method includes a reaction step in which a compound capable of introducing an imino group is reacted with an elastomeric polymer having cyclic acid anhydride groups on side chains.

(n) The method of preparing the thermoplastic elastomer according to (m) above which additionally includes a reaction step in which a compound capable of introducing a nitrogen heterocycle is reacted.

(o) A thermoplastic elastomer composition which includes the thermoplastic elastomer according to any one of (a) to (l) above.

(p) The thermoplastic elastomer composition according to (o) above which additionally includes from 1 to 200 parts by weight of carbon black and/or silica per 100 parts by weight of the thermoplastic elastomer.

### BEST MODE FOR CARRYING OUT THE INVENTION

The invention is described more fully below.

The thermoplastic elastomer according to a first aspect of the present invention (sometimes referred to below simply as “the thermoplastic elastomer of the first aspect”) is a hydrogen-bondable thermoplastic elastomeric composed of an elastomeric polymer having, on side chains, carbonyl-bearing groups and imidazole rings, which rings bear a hydrogen atom on a nitrogen atom and also bear a substituent which is an alkyl, aralkyl or aryl group.

The thermoplastic elastomer of the first aspect has specific imidazole rings on side chains. As described subsequently, to enhance the mechanical strength, it is desirable that these imidazole rings bear a hydrogen atom on a nitrogen atom thereof. However, because there is a possibility that the hydrogen atom will form a crosslink with another functional group, this thermoplastic elastomer also tends to gel easily. In the course of investigations, the inventor found that by introducing onto the imidazole ring an alkyl, aralkyl or aryl group, preferably at the 2, 4 or 5 position on the imidazole ring, the hydrogen atom on the nitrogen atom of the imidazole ring can be sterically blocked, which discourages such crosslinking and enables gelation to be suppressed.

Therefore, the thermoplastic elastomer of the first aspect having this type of specific imidazole ring, by suppressing gelation, is able to ensure recyclability and moreover has a mechanical strength, especially a compression set, that is excellent.

The alkyl, aralkyl and aryl groups are not subject to any particular limitation. However, alkyl groups of 1 to 20 carbons, aralkyl groups of 7 to 20 carbons, and aryl groups of 6 to 20 carbons are preferred for reasons having to do with availability, the fact that they do not hamper compatibility with the main chain polymer (elastomeric polymer), and because the formation of hydrogen bonds in which the hydrogen atom on the imidazole ring participates is not excessively impeded by too large a steric hindrance.

Specific examples include linear alkyl groups such as methyl, ethyl, propyl, butyl, pentyl, octyl, dodecyl and stearyl; branched alkyl groups such as isopropyl, isobutyl, s-butyl, t-butyl, isopentyl, neopentyl, t-pentyl, 1-methylbutyl, 1-methylheptyl and 2-ethylhexyl; aralkyl groups such as benzyl and phenethyl; and aryl groups such as phenyl, o-tolyl, m-tolyl, p-tolyl, dimethylphenyl and mesityl. Each of these may have substituents.

Of the above, alkyl groups having 1 to 6 carbons (e.g., methyl, ethyl, propyl, butyl) and phenyl groups are especially preferred because they can effectively block the hydrogen atom on the nitrogen atom of the imidazole ring while leaving the hydrogen bondability intact.

The alkyl, aralkyl and aryl groups are preferably introduced at the 2, 4 or 5 position on the imidazole ring. Introduction at the 2 position is more preferable because effective steric blocking of the hydrogen atom on the nitrogen atom is possible.

In the thermoplastic elastomer of the first aspect, the specific imidazole ring described above is introduced onto the main chain either directly or through an intervening organic group. Introduction to the main chain through an organic group is preferred.

It is preferable for the imidazole ring to be bonded to the elastomeric polymer—that is, the main chain—at the 4 or 5 position, either directly or through an organic group. Even when the carbonyl group and the imidazole ring are present on the same side chain, because the nitrogen atoms of the imidazole ring are situated at a distance from the carboxy group, hydrogen bonds do not readily form within the molecule and so an increase in the crosslink strength (tensile strength of the composition) owing to the formation of intermolecular hydrogen bonds and ionic bonds can be expected, in addition to which the crosslink density is greater. Bonding at the 5 position is especially preferred.

By selecting the above bonding position on the imidazole ring, the thermoplastic elastomer of the first aspect has an excellent mechanical strength and compression set because crosslinks by hydrogen bonds, ionic bonds and the like readily form between molecules of the thermoplastic elastomer.

In the thermoplastic elastomer of the first aspect, the carbonyl-containing group and the imidazole ring may be introduced onto a main chain as mutually independent side chains or the carbonyl-containing group and the imidazole ring may be bonded to a single side chain through a mutually differing group and thereby introduced onto the main chain.

It is preferable for the carbonyl-containing group and the imidazole ring to be introduced onto the main chain as a single side chain of formula (1) or (2) below.

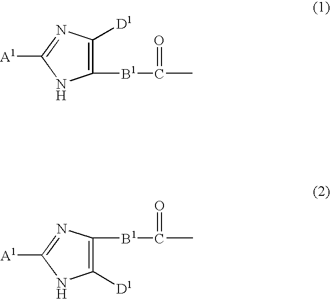

In these formulas, A¹ is an alkyl group of 1 to 20 carbons, an aralkyl group of 7 to 20 carbons or an aryl group of 6 to 20 carbons; B¹ is a single bond, an oxygen, nitrogen or sulfur atom, or an organic group which may include these atoms; and D¹ is a hydrogen atom, an alkyl group of 1 to 20 carbons, an aralkyl group of 7 to 20 carbons, or an aryl group of 6 to 20 carbons.

Here, specific examples of the substituent A¹ include the above-mentioned alkyl groups of 1 to 20 carbons, aralkyl groups of 7 to 20 carbons, and aryl groups of 6 to 20 carbons.

Specific examples of the substituent D¹ include a hydrogen atom, the above-mentioned alkyl groups of 1 to 20 carbons, aralkyl groups of 7 to 20 carbons, and aryl groups of 6 to 20 carbons.

The substituent B¹ is a single bond, an oxygen, nitrogen or sulfur atom, or an organic group which may include these atoms. Specific examples include a single bond; an oxygen atom, sulfur atom or an amino group NR′ (R′ being a hydrogen atom or an alkyl group of 1 to 10 carbons); alkylene or aralkylene groups of 1 to 20 carbons which may include these atoms or groups; alkylene ether groups (alkyleneoxy groups, such as —O—CH₂CH₂—), alkyleneamino groups (e.g., —NH—CH₂CH₂—) and alkylene thioether groups (alkylenethio groups, such as —S—CH₂CH₂—) of 1 to 20 carbons which are terminated with these atoms or group; and aralkylene ether groups (aralkyleneoxy groups), aralkyleneamino groups and aralkylene thioether groups of 1 to 20 carbons which are terminated with these atoms or group.

Exemplary alkyl groups having 1 to 10 carbons on the amino group NR′ are methyl, ethyl, propyl, butyl, pentyl, hexyl, heptyl, octyl, nonyl and decyl, including isomers thereof.

With regard to the above substituent B¹, it is preferable for the oxygen atom, sulfur atom and amino group NR′, and for the oxygen atom, nitrogen atom and sulfur atom on the alkylene ether groups, alkyleneamino groups, alkylene thioether groups, aralkylene ether groups, aralkyleneamino groups and aralkylene thioether groups of 1 to 20 carbons terminated with an oxygen atom, nitrogen atom or sulfur atom, to form, in combination with a neighboring carbonyl group, the ester, amide, imide, or thioester ester group of a conjugated system.

Of the above, the substituent B¹ is preferably an oxygen atom, sulfur atom or amino group which forms a conjugated system, or an alkylene ether group, alkyleneamino group or alkylene thioether group of 1 to 20 carbons terminated with these atoms or group. An amino group (NH), alkyleneamino group (—NH—CH₂—, —NH—CH₂CH₂—, —NH—CH₂CH₂CH₂—), or alkylene ether group (—O—CH₂—, —O—CH₂CH₂—, —O—CH₂CH₂CH₂—) is especially preferred.

It is more preferable for the carbonyl-containing group and the imidazole ring to be introduced onto the main chain at the α or β position as one of the side chains of formulas (3) to (6) below.

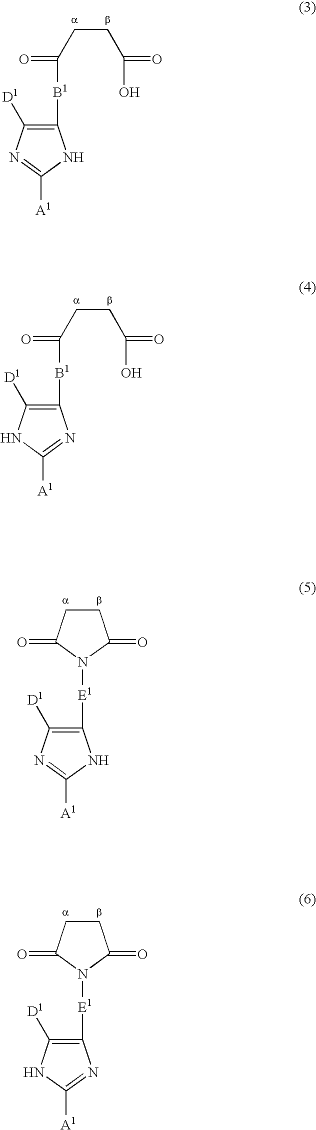

In these formulas, A¹ is an alkyl group of 1 to 20 carbons, an aralkyl group of 7 to 20 carbons or an aryl group of 6 to 20 carbons; B¹ and E¹ are each independently a single bond, an oxygen, nitrogen or sulfur atom, or an organic group which may include these atoms; and D¹ is a hydrogen atom, an alkyl group of 1 to 20 carbons, an aralkyl group of 7 to 20 carbons or an aryl group of 6 to 20 carbons.

Here, the substituent A¹ is basically the same as the substituent A¹ of above formula (1), substituents B¹ and E¹ are each independently basically the same as the substituent B¹ of above formula (1), and the substituent D¹ is basically the same as the substituent D¹ of above formula (1).

The thermoplastic elastomer of the first aspect has carbonyl-containing groups and imidazole ring on side chains of an elastomeric polymer that is a natural polymer or a synthetic polymer.

In the first aspect of the present invention, the term “side chains” refers to the side chains and ends of the elastomeric polymer. Moreover, the phrase “has carbonyl-containing groups and imidazole rings on side chains” means that carbonyl-containing groups and imidazole rings are stably bonded chemically (covalently bonded) to atoms (generally carbons) that form the main chain of the elastomeric polymer.

The elastomeric polymer serving as the main chain of the thermoplastic elastomer of the first aspect is generally a known natural polymer or synthetic polymer, and is not subject to any particular limitation provided it is a polymer having a glass transition point of room temperature (25° C.) or below, that is, an elastomer.

Specific examples of such elastomeric polymers include diene rubbers such as natural rubber (NR), isoprene rubber (IR), butadiene rubber (BR), 1,2-butadiene rubber, styrene-butadiene rubber (SBR), acrylonitrile-butadiene rubber (NBR), chloroprene rubber (CR), butyl rubber (IIR) and ethylene-propylene-diene rubber (EPDM), as well as hydrogenation products thereof; olefin rubbers such as ethylene-propylene rubber (EPM), ethylene-acrylic rubber (AEM), ethylene-butene rubber (EBM), chlorosulfonated polyethylene rubber, acrylic rubber, fluororubber, polyethylene rubber and polypropylene rubber; and also epichlorohydrin rubber, polysulfide rubber, silicone rubber and urethane rubber.

The elastomeric polymer may be a resin component-containing elastomeric polymer (thermoplastic elastomeric polymer). Specific examples include polystyrene-based elastomeric polymers (e.g., SBS, SIS, SEBS), polyolefin-based elastomeric polymers, polyvinyl chloride-based elastomeric polymers, polyurethane-based elastomeric polymers, polyester-based elastomeric polymers, polyamide-based elastomeric polymers, fluorocarbon-based elastomeric polymers and silicone-based elastomeric polymers that may be hydrogenated.

The above elastomeric polymer may be in either liquid or solid form and has a molecular weight which is not subject to any particular limitation and may be suitably selected according to such considerations as the intended use of the thermoplastic elastomer of the first aspect and of a thermoplastic elastomer composition according to a second aspect of the present invention that includes the thermoplastic elastomer (which is referred to below simply as “the thermoplastic elastomer composition of the second aspect”), as well as the physical properties required thereof.

When importance is placed on the flow properties on heating (decrosslinking) of the thermoplastic elastomer of the first aspect and the thermoplastic elastomer composition of the second aspect (these are sometimes referred to collectively below as “the thermoplastic elastomer (composition) of the first and second aspects”), it is preferable for the elastomeric polymer to be in a liquid state. In the case of a diene rubber such as isoprene rubber or butadiene rubber, for example, the weight-average molecular weight is preferably from 1,000 to 100,000, and more preferably about 1,000 to 50,000.

On the other hand, when importance is placed on the strength of the thermoplastic elastomer (composition) of the first and second aspects, it is preferable for the elastomeric polymer to be in a solid state. In the case of a diene rubber such as isoprene rubber or butadiene rubber, for example, the weight-average molecular weight is preferably at least 100,000, and most preferably about 500,000 to 1,500,000.

In the first and second aspects of the present invention, the weight-average molecular weight is the polystyrene equivalent weight-average molecular weight measured by gel permeation chromatography (GPC). Tetrahydrofuran (THF) is used as the solvent in measurement.

In the first and second aspects of the present invention, two or more of the above elastomeric polymers may be used in admixture. The mixing ratio between the respective elastomeric polymers in this case may be set to any ratio in accordance with such considerations as the use to which the thermoplastic elastomer (composition) of the first and second aspects is to be put and the physical properties required of the thermoplastic elastomer (composition) of the first and second aspects.

As mentioned above, the glass transition point of the elastomeric polymer is preferably 25° C. or below. If the elastomeric polymer has two or more glass transition points or a mixture of two or more elastomeric polymers is used, it is preferable for at least one of the glass transition points to be 25° C. or below. It is desirable for the glass transition point of the elastomeric polymer to be within this range because molded parts obtained from the thermoplastic elastomer (composition) of the first and second aspects will consequently exhibit rubbery elasticity at room temperature.

In the first and second aspects of the present invention, the glass transition point is a value obtained by measurement using differential scanning calorimetry (DSC) at a temperature rise rate of 10° C./min.

Diene rubbers such as natural rubber (NR), isoprene rubber (IR), butadiene rubber (BR), 1,2-butadiene rubber, styrene-butadiene rubber (SBR), acrylonitrile-butadiene rubber (NBR), ethylene-propylene-diene rubber (EPDM), and butyl rubber (IIR); olefin rubbers such as ethylene-propylene rubber (EPM), ethylene-acrylic rubber (AEM) and ethylene-butene rubber (EBM); and ethylene-vinyl acetate copolymers (EVA), ethylene-ethyl acrylate copolymers (EEA), styrene-butadiene-styrene block copolymers (SBS) and hydrogenation products thereof (SEBS), styrene-ethylene-propylene-styrene block copolymers (SEPS), styrene-isoprene-styrene block copolymers (SIS) and styrene-isobutylene-styrene block copolymers (SIBS) are preferred as the elastomeric polymer because they have a glass transition point of 25° C. or below and molded parts composed of the thermoplastic elastomer (composition) of the first and second aspects exhibit rubber elasticity at room temperature. Moreover, when a diene rubber is used, the subsequently described modification with maleic anhydride or the like is easy. When an olefin rubber is used, once the composition has been crosslinked the tensile strength of the composition increases and deterioration of the composition is suppressed owing to the absence of double bonds.

In the first and second aspects of the present invention, the bonded styrene content in the styrene-butadiene rubber (SBR), styrene-butadiene-styrene block copolymer (SBS), hydrogenated styrene-butadiene-styrene block copolymer (SEBS), styrene-ethylene-propylene-styrene block copolymer (SEPS), styrene-isoprene-styrene block copolymer (SIS) and styrene-isoprene-styrene block copolymer (SIBS), the bonded acrylonitrile content in the acrylonitrile-butadiene rubber (NBR), and the hydrogenation ratio in the hydrogenated elastomeric polymers are not subject to any particular limitations, and may be set to any values in accordance with such considerations as the intended use of the thermoplastic elastomer (composition) of the first and second aspects of the present invention and the physical properties required of the thermoplastic elastomer (composition) of the first and second aspects.

If ethylene-propylene-diene rubber (EPDM), ethylene-acrylic rubber (AEM), ethylene-propylene rubber (EPM), ethylene-butene rubber (EBM), ethylene-vinyl acetate copolymer (EVA), ethylene-ethyl acrylate copolymer (EEA), styrene-butadiene-styrene block copolymer (SBS) or the hydrogenation product thereof (SEBS) is used as the main chain of the thermoplastic elastomer of the first aspect, the ethylene content is preferably 10 to 90 mol %, and more preferably 40 to 90 mol %. An ethylene content within this range is advantageous because the thermoplastic elastomer (composition) obtained therefrom has an excellent compression set and an excellent mechanical strength.

The thermoplastic elastomer of the first aspect has carbonyl-containing groups on side chains of the elastomeric polymer.

The carbonyl-containing groups are not subject to any particular limitation so long as they include a carbonyl group. Specific examples include amide, ester, imide, carboxyl and carbonyl groups. Compounds capable of introducing such groups are not subject to any particular limitation, and include ketones, carboxylic acids, and derivatives thereof.

Exemplary carboxylic acids include organic acids containing a saturated or unsaturated hydrocarbon group. Exemplary hydrocarbon groups include aliphatic, alicyclic and aromatic groups. Exemplary carboxylic acid derivatives include carboxylic anhydrides, amino acids, thiocarboxylic acids (mercapto group-bearing carboxylic acids), esters, amino acids, ketones, amides, imides, dicarboxylic acids and monoesters thereof.

Specific examples of carboxylic acids and derivatives thereof include carboxylic acids such as malonic acid, maleic acid, succinic acid, glutaric acid, phthalic acid, isophthalic acid, terephthalic acid, p-phenylenediacetic acid, p-hydroxybenzoic acid, p-aminobenzoic acid, mercaptoacetic acid, and these same carboxylic acids which bear also a substituent; acid anhydrides such as succinic anhydride, maleic anhyride, glutaric anhydride, phthalic anhydride, propionic anhydride and benzoic anhydride; aliphatic esters such as maleic acid esters, malonic acid esters, succinic acid esters, glutaric acid esters and ethyl acetate; aromatic esters such as phthalic acid esters, isophthalic acid esters, terephthalic acid esters, ethyl m-aminobenzoate and methyl p-hydroxybenzoate; ketones such as quinone, anthraquinone and naphthoquinone; amino acids such as glycine, tyrosine, bicine, alanine, valine, leucine, serine, threonine, lysine, aspartic acid, glutamic acid, cysteine, methionine, proline and N-(p-aminobenzoyl)-β-alanine; amides such as maleamide, maleamic acid (maleic acid monoamide), succinic acid monoamide, 5-hydroxyvaleramide, N-acetylethanolamine, N,N′-hexamethylenebis(acetamide), malonamide, cycloserine, 4-acetamidophenol and p-acetamidobenzoic acid; and imides such as maleimide and succinimide.

Of these, the compound capable of introducing a carbonyl group (carbonyl-containing group) is preferably a cyclic anhydride such as succinic anhydride, maleic anhydride, glutaric anhydride or phthalic anhydride. Maleic anhydride is especially preferred.

The ratio between the carbonyl-containing groups and the imidazole rings on the thermoplastic elastomer of the first aspect is not subject to any particular limitation, although a ratio of 2:1 (1:1 in the case of imide structures of above formulas (5) and (6)) is preferred because it facilitates the formation of complementary interactions and also enables preparation to be easily carried out.

Side chains bearing the above carbonyl-containing groups and imidazole rings are introduced in a ratio (introduction ratio) of preferably 0.1 to 50 mol %, and more preferably 0.5 to 30 mol %, per 100 mol % of the main chain portion.

At less than 0.1 mol %, the tensile strength when crosslinked may be inadequate, whereas at more than 50 mol %, the crosslink density becomes high, which may result in a loss of rubber elasticity. That is, a introduction ratio within the above range is advantageous because crosslinks between molecules efficiently form due to interactions between side chains on the thermoplastic elastomer of the first aspect, giving compositions prepared therefrom a very high tensile strength when crosslinked and an excellent recyclability.

In cases where the carbonyl-containing groups and imidazole rings are introduced independently, the two moieties may be thought of as pairs and, depending on the relative ratios of the carbonyl-containing groups and the imidazole rings, if there is an excess of one moiety, the more abundant moiety may be regarded as the basis for the introduction ratio.

For example, when the main chain portion is an ethylene-propylene rubber (EPM), the above introduction ratio of monomer units with introduced side chains is equivalent to 0.1 to 50 units per 100 units of ethylene and propylene monomer unit.

The thermoplastic elastomer of the first aspect preferably has a glass transition point of 25° C. or below. If the thermoplastic elastomer has two or more glass transition points or two or more elastomers are used together, it is preferable for at least one of the glass transition points to be 25° C. or below. It is desirable for the glass transition point of the thermoplastic elastomer of the first aspect to be within this range because molded parts obtained from the resulting thermoplastic elastomer composition of the second aspect will exhibit rubbery elasticity at room temperature.

An ordinary method may be selected without particular limitation as the method for preparing the thermoplastic elastomer of the first aspect.

Of the thermoplastic elastomers of the first aspect, ones in which the carbonyl-containing groups and the imidazole rings are located on the same side chains can be prepared by, for example, reacting a compound capable of introducing the imidazole ring with a carbonyl-containing group-modified elastomer that has been obtained by modifying the above-described elastomeric polymer with the above-described carbonyl-containing groups.

For example, the thermoplastic elastomer of the first aspect may be obtained by reacting a diene rubber such as butadiene rubber, an olefin rubber such as ethylene-propylene rubber (EPM) or an α-olefin such as propylene with a toluene solution containing maleic anhydride or mercaptoacetic acid, at room temperature or under heating, in the presence or absence of a radical initiator such as a peroxide, and in a nitrogen atmosphere or in air, so as to synthesize a carbonyl-containing group-modified elastomer, then reacting this carbonyl-containing group-modified elastomer with a compound capable of introducing an imidazole ring.

Here, the “compound capable of introducing an imidazole ring” may be an imidazole ring itself, or an imidazole ring having a substituent (e.g., hydroxyl group, thiol group, amino group) that reacts with a carbonyl-containing group such as maleic anhydride.

The above compound capable of introducing an imidazole ring may be reacted with some or all of the carbonyl-containing groups on the carbonyl-containing group-modified elastomer. Here, “some” is preferably at least 1 mol %, more preferably at least 50 mol %, and most preferably at least 80 mol %, per 100 mol % of the carbonyl-containing groups. An amount within this range is preferable because introducing the imidazole rings has a discernible effect and increases the tensile strength of the thermoplastic elastomer when crosslinked. Reaction of the above compound capable of introducing an imidazole ring with all (100 mol %) of the carbonyl-containing groups is especially preferred for achieving an excellent recyclability, compression set and tensile strength.

A commercial product may be used as the above carbonyl-containing group-modified elastomer. Specific examples include maleic anhydride-modified isoprene rubbers such as LIR-403 (produced by Kuraray Co., Ltd.) and LIR-410A (test product of Kuraray Co., Ltd.); modified isoprene rubbers such as LIR-410 (produced by Kuraray Co., Ltd.); carboxy-modified nitrile rubbers such as Krynac 110, 221 and 231 (produced by Polysar); carboxy-modified polybutenes such as CPIB (produced by Nippon Petrochemicals Co., Ltd.) and HRPIB (laboratory test product of Nippon Petrochemicals Co., Ltd.); maleic anhydride-modified ethylene-propylene rubbers such as Nucrel (produced by DuPont-Mitsui Polychemicals Co., Ltd.), Yukalon (produced by Mitsubishi Chemical Corporation) and Tafmer M (e.g., MA8510 (produced by Mitsui Chemicals, Inc.)); maleic anhydride-modified ethylene-butene rubbers such as Tafiner M (e.g., MH7020 produced by Mitsui Chemicals, inc.)); maleic anhydride-modified polyethylenes such as the Adtex series (maleic anhydride-modified EVA, maleic anhydride-modified EMA (produced by Japan Polyolefin Co.)), HPR series (maleic anhydride-modified EEA, maleic anhydride-modified EVA (produced by DuPont-Mitsui Polychemicals Co., Ltd.)), Bondfast series (maleic anhydride-modified EMA (Sumitomo Chemical Co., Ltd.)), Dumilan series (maleic anhydride-modified EVOH (produced by Takeda Pharmaceutical Company, Ltd.)), Bondine (maleic anhydride-modified EEA (produced by Atofina)), Tuftec (maleic anhyride-modified SEBS, M1943 (produced by Asahi Kasei Kogyo Co., Ltd.)), Kraton (maleic anhydride-modified SEBS, FG1901X (produced by Kraton Polymer)), Tufpren (maleic anhydride-modified SBS, 912 (produced by Asahi Kasei Kogyo Co., Ltd.)), Septon (maleic anhydride-modified SEPS (produced by Kuraray Co., Ltd.)), Rexpearl (maleic anhydride-modified EEA, ET-182G, 224M, 234M (produced by Japan Polyolefin Co.)), and Auroren (maleic anhydride-modified EEA, 200S, 250S (produced by Nippon Paper Chemicals Co., Ltd.)); and maleic anhydride-modified polypropylenes such as Admer (e.g., QB550, LF128 (produced by Mitsui Chemicals, Inc.)).

Alternatively, a compound capable of introducing the above carbonyl-containing group and a compound capable of introducing the above imidazole ring can be reacted together, then inserted onto the side chains of the elastomeric polymer.

To prepare a thermoplastic elastomer having the carbonyl-containing groups and the imidazole rings each independently on side chains, a monomer having a carbonyl-containing group and a monomer having an imidazole ring may be copolymerized so as to directly prepare the thermoplastic elastomer of the first aspect, or the main chain (elastomeric polymer) may be formed beforehand such as by polymerization, then graft-modified with compounds capable of introducing the above carbonyl-containing groups and the above imidazole rings.

In such a method of preparation, commonly used analytic techniques such as NMR and IR spectroscopy can be used to check whether the groups on the side chains of the thermoplastic elastomer of the first aspect are independently bonded or mutually bonded.

Of the above methods for preparing the thermoplastic elastomer of the first aspect, the method is preferably one that involves first preparing a carbonyl-containing group-modified elastomer in which carbonyl-containing groups have been introduced, then introducing the above imidazole rings onto this elastomer by reacting it with a compound capable of introducing imidazole rings. The method is most preferably one in which an elastomeric polymer having cyclic acid anhydrides on side chains and the compound capable of introducing the above imidazole ring are reacted at a temperature at which the compound capable of introducing the imidazole ring can chemically bond (e.g., covalently bond, ionically bond) with the cyclic acid anhydride groups. In this way, carbonyl-containing groups and imidazole rings can be introduced onto the main chain of the elastomeric polymer (ring opening of the cyclic acid anhydride groups).

Preparation of the thermoplastic elastomer of the first aspect is described in detail in JP 2000-169527 A.

In an elastomer having on side chains both carbonyl-containing groups and imidazole rings bearing a hydrogen atom on a nitrogen atom, during hydrogen bonding, the carbonyl-containing groups can serve as acceptors and the hydrogen atoms on the nitrogen atom of the imidazole rings can serve as donors. As a result, there are formed thermotropic hydrogen-bondable crosslinking structures which can repeatedly undergo crosslink formation at room temperatures (during use) and decrosslinking and fluidization under heating. Moreover, the elastomer having the above side chains readily form hydrogen bonds that are stable at high temperatures and thus capable of withstanding use at high temperatures. As a result, the elastomer exhibits rubber properties sufficient for practical use as a rubber yet has excellent fluidity when heated to a high temperature. Also, compared with conventional, general-purpose thermoplastic elastomers, the properties inherent to these thermoplastic elastomers of the present invention can be fully manifested without the need to include a thermoplastic resin for the purpose of forming a constrained phase. In addition, by introducing an alkyl, aralkyl or aryl group at the 2 position on the imidazole ring, the hydrogen atom on the nitrogen atom of the imidazole rings is sterically hindered, discouraging the formation of permanent crosslinks and thus making it possible to suppress gelation. Therefore, the thermoplastic elastomers of the present invention having this type of specific imidazole ring ensure recyclability by suppressing gelation, and also have an excellent mechanical strength and compression set.

Next, a thermoplastic elastomer according to a third aspect of the present invention (sometimes referred to below as simply “the thermoplastic elastomer of the third aspect”) is described in detail.

The thermoplastic elastomer of the third aspect is a thermoplastic elastomer having side chains which include a structure of formula (7) above.

Although the details of why the thermoplastic elastomer of the third aspect maintains an excellent recyclability and also has an excellent mechanical strength, especially an excellent compression set, are not entirely clear, the reason appears to be as follows.

Because the side chains of the thermoplastic elastomer include a structure of above formula (7), the imino groups presumably form strong hydrogen bonds with carboxylic acids and carbonyl groups, and can thus act as strong crosslinking points.

The thermoplastic elastomer of the third aspect has side chains which include a structure of above formula (7) on an elastomeric polymer that is a natural polymer or a synthetic polymer.

In the third aspect of the present invention, “side chain” refers to the side chains and ends of the elastomeric polymer. Moreover, the phrase “has side chains which include a structure of above formula (7)” means that structures of above formula (7) are stably bonded chemically (e.g., covalently bonded, ionically bonded) to atoms (generally carbon atoms) that form the main chain of the elastomeric polymer.

The elastomeric polymer serving as the main chain of the thermoplastic elastomer of the third aspect is generally a known natural polymer or synthetic polymer, and is not subject to any particular limitation provided it is a polymer having a glass transition point of room temperature (25° C.) or below, that is, an elastomer. It is basically the same as the elastomeric polymer serving as the main chain of the earlier thermoplastic elastomer of the first aspect of the present invention.

The thermoplastic elastomer of the third aspect has side chains which include a structure of formula (7) below on the above-described elastomeric polymer.

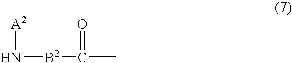

In the formula, A² is an alkyl group of 1 to 30 carbons, an aralkyl group of 7 to 20 carbons or an aryl group of 6 to 20 carbons; and B² is a single bond, an oxygen atom, an amino group NR′ (R′ being a hydrogen atom or an alkyl group of 1 to 10 carbons), a sulfur atom, or an organic group which may include these atoms or group.

The substituent A² is not subject to any particular limitation so long as it is an alkyl group of 1 to 30 carbons, an aralkyl group of 7 to 20 carbons, or an aryl group of 6 to 20 carbons.

Specific examples of such substituents A² include linear alkyl groups such as methyl, ethyl, propyl, butyl, pentyl, octyl, dodecyl and stearyl; branched alkyl groups such as isopropyl, isobutyl, s-butyl, t-butyl, isopentyl, neopentyl, t-pentyl, 1-methylbutyl, 1-methylheptyl and 2-ethylhexyl; aralkyl groups such as benzyl and phenethyl; and aryl groups such as phenyl, o-tolyl, m-tolyl, p-tolyl, dimethylphenyl and mesityl.

Of these, alkyl groups, particularly butyl, octyl, dodecyl, isopropyl and 2-ethylhexyl, are preferred because of the good processability of the thermoplastic elastomer of the third aspect and of thermoplastic elastomer compositions of a fourth aspect of the present invention which contain such thermoplastic elastomers (sometimes referred to below as simply “the thermoplastic elastomer composition of the fourth aspect”; the thermoplastic elastomer of the third aspect and the thermoplastic elastomer composition of the fourth aspect are sometimes referred to collectively as “thermoplastic elastomer (composition) of the third and fourth aspects”).

The substituent B² is not subject to any particular limitation, provided it is a single bond, an oxygen atom, an amino group NR′ (R′ being a hydrogen atom or an alkyl group of 1 to 10 carbons), a sulfur atom, or an organic group which may include these atoms or group.

Specific examples of this substituent B² include, as with B¹ in above formulas (1) and (2): a single bond; an oxygen atom, a sulfur atom or an amino group NR′ (R′ being a hydrogen atom or an alkyl group of 1 to 10 carbons); alkylene or aralkylene groups of 1 to 20 carbons which may include these atoms or group; alkylene ether groups (alkyleneoxy groups, such as —O—CH₂CH₂—), alkyleneamino groups (e.g., —NH—CH₂CH₂—) and alkylene thioether groups (alkylenethio groups, such as —S—CH₂CH₂—) of 1 to 20 carbons which are terminated with these atoms or group; and aralkylene ether groups (aralkyleneoxy groups), aralkyleneamino groups and aralkylene thioether groups of 1 to 20 carbons which are terminated with these atoms or group.

Exemplary alkyl groups having 1 to 10 carbons on the amino group NR′ are, as with B¹ in above formulas (1) and (2), methyl, ethyl, propyl, butyl, pentyl, hexyl, heptyl, octyl, nonyl and decyl, including isomers thereof.

With regard to the above substituent B², as with B¹ in above formulas (1) and (2), it is preferable for the oxygen atom, sulfur atom and amino group NR′, and for the oxygen atom, amino group NR′ and sulfur atom on the alkylene ether groups, alkyleneamino groups, alkylene thioether groups, aralkylene ether groups, aralkyleneamino groups and aralkylene thioether groups of 1 to 20 carbons terminated with these atoms or this amino group, to form, in combination with a neighboring carbonyl group, the ester, amide, imide, or thioester ester group of a conjugated system.

Of the above, the substituent B² is preferably an oxygen atom, sulfur atom or amino group which forms a conjugated system, or an alkylene ether group, alkyleneamino group or alkylene thioether group of 1 to 20 carbons terminated with these atoms or group. An amino group (NH), alkyleneamino group (—NH—CH₂—, —NH—CH₂CH₂—, —NH—CH₂CH₂CH₂—), or alkylene ether group (—O—CH₂—, —O—CH₂CH₂—, —O—CH₂CH₂CH₂—) is especially preferred.

In the thermoplastic elastomer of the third aspect, the side chains which include a structure of formula (7) preferably have a structure of formula (8) or (9) below which bonds to a main chain at the α or β position.

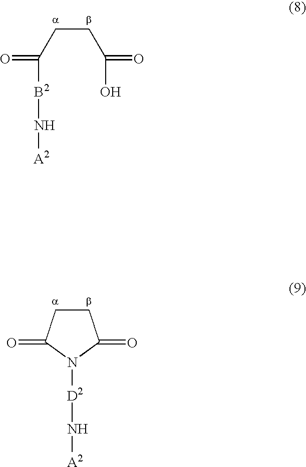

In the formula, A² is an alkyl group of 1 to 30 carbons, an aralkyl group of 7 to 20 carbons, or an aryl group of 6 to 20 carbons; B² and D² are each independently a single bond, an oxygen atom, an amino group NR′ (R′ being a hydrogen atom or an alkyl group of 1 to 10 carbons), a sulfur atom, or an organic group which may include these atoms or group.

Here, the substituent A² is basically the same as the substituent A² in above formula (7). Substituents B² and D² are each independently basically the same as the substituent B² in formula (7).

However, of the possibilities listed for substituent B² in above formula (7), the substituent D² in above formula (9) is preferably a single bond or an alkylene or aralkylene group of 1 to 20 carbons which may include an oxygen atom, an amino group NR′ or a sulfur atom and which forms a conjugated system with the imide nitrogen. An alkylene group is especially preferred. That is, together with the imide nitrogen in above formula (9), it is preferable to form an alkyleneamino or aralkyleneamino group of 1 to 20 carbons which may include an oxygen atom, an amino group NR′ or a sulfur atom. It is especially preferable to form an alkyleneamino group.

Specific examples of such substituents D² include a single bond; the above-described alkylene ether, alkyleneamino, alkylene thioether, aralkylene ether, aralkyleneamino and aralkylene thioether groups of 1 to 20 carbons terminated with an oxygen atom, sulfur atom or amino group; and methylene, ethylene, propylene, butylene, hexylene, phenylene and xylylene groups, including isomers thereof.

The side chains which include a structure of above formula (7) or of above structure (8) or (9) are preferably introduced in a ratio (introduction ratio) of 0.1 to 50 mol % per 100 mol % of the monomers making up the elastomeric polymer. At less than 0.1 mol %, the strength when crosslinked may be inadequate, whereas at more than 50 mol %, the crosslink density is high, which may lead to a loss in rubber elasticity. If the introduction ratio is within this range, interactions between side chains on the elastomeric polymer will arise intermolecularly or intramolecularly. These form in a good balance, and so the resulting thermoplastic elastomer (composition) of the third or fourth aspect has a high tensile strength when crosslinked, excellent recyclability, and a good compression set. For these properties to be even better, the introduction of side chains in a ratio of 0.1 to 30 mol % is more preferred, and the introduction of side chains in a ratio of 0.5 to 20 mol % is even more preferred.

In addition to the side chains containing a structure of above formula (7) or of above formula (8) or (9), it is preferable for the elastomeric polymer in the thermoplastic elastomer of the third aspect to have also side chains which include a nitrogen heterocycle.

In the third aspect of the present invention, this nitrogen heterocycle is introduced onto the main chain of the elastomeric polymer, either directly or through an organic group.

So long as it includes a nitrogen atom within the ring, the nitrogen heterocycle that is used may also include a heteroatom other than nitrogen within the ring, such as a sulfur, oxygen or phosphorus atom. Here, a heterocyclic compound is used because having a heterocyclic structure strengthens the hydrogen bonds which form crosslinks, enhancing the tensile strength of the thermoplastic elastomer (composition) of the third and fourth aspect.

The above nitrogen heterocycle may have a substituent. Specific examples of the substituent include alkyl groups such as methyl, ethyl, (iso)propyl and hexyl; alkoxy groups such as methoxy, ethoxy and (iso)propoxy; groups composed of halogen atoms such as fluorine, chlorine, bromine and iodine; and also cyano groups, amino groups, aromatic hydrocarbon groups, ester groups, ether groups, acyl groups and thioether groups. Combinations of these may also be used. No particular limitation is imposed on the positions at which these substituents are introduced or on the number of substituents.

The nitrogen heterocycle may or may not have aromaticity, although it is preferable for the nitrogen heterocycle to have aromaticity because the resulting thermoplastic elastomer (composition) of the third or fourth aspect will have a higher tensile strength and a better mechanical strength when crosslinked.

The nitrogen heterocycle is preferably a five- or six-membered ring.

Specific examples of such nitrogen heterocycles include pyrrololine, pyrrolidone, oxindole(2-oxindole), indoxyl(3-oxindole), dioxindole, isatin, indolyl, phthalimidine, β-isoindigo, monoporphyrin, diporphyrin, triporphyrin, azaporphyrin, phthalocyanine, hemoglobin, uroporphyrin, chlorophyll, phylloerythrin, imidazole, pyrazole, triazole, tetrazole, benzoimidazole, benzopyrazole, benzotriazole, imidazoline, imidazolone, imidazolidone, hydantoin, pyrazoline, pyrazolone, pyrazolidone, indazole, pyridoindole, purine, cinnoline, pyrrole, pyrroline, indole, indoline, oxindole, carbazole, phenothiazine, indolenine, isoindole, oxazole, thiazole, isooxazole, isothiazole, oxadiazole, thiadiazole, oxatriazole, thiatriazole, phenanthroline, oxazine, benzoxazine, phthalazine, pteridine, pyrazine, phenazine, tetrazine, benzoxazole, benzoisoxazole, anthranil, benzothiazole, benzofurazane, pyridine, quinoline, isoquinoline, acridine, phenanthridine, anthrazoline, naphthyridine, thiazine, pyridazine, pyrimidine, quinazoline, quinoxaline, triazine, histidine, triazolidine, melamine, adenine, guanine, thymine, cytosine, and derivatives thereof. Of these, especially preferred nitrogen five-membered rings include the following compounds, triazole derivatives of formula (22) below, and imidazole derivatives of formula (23) below. These may have the various above-mentioned substituents, and may be hydrogenated or dehydrogenated.

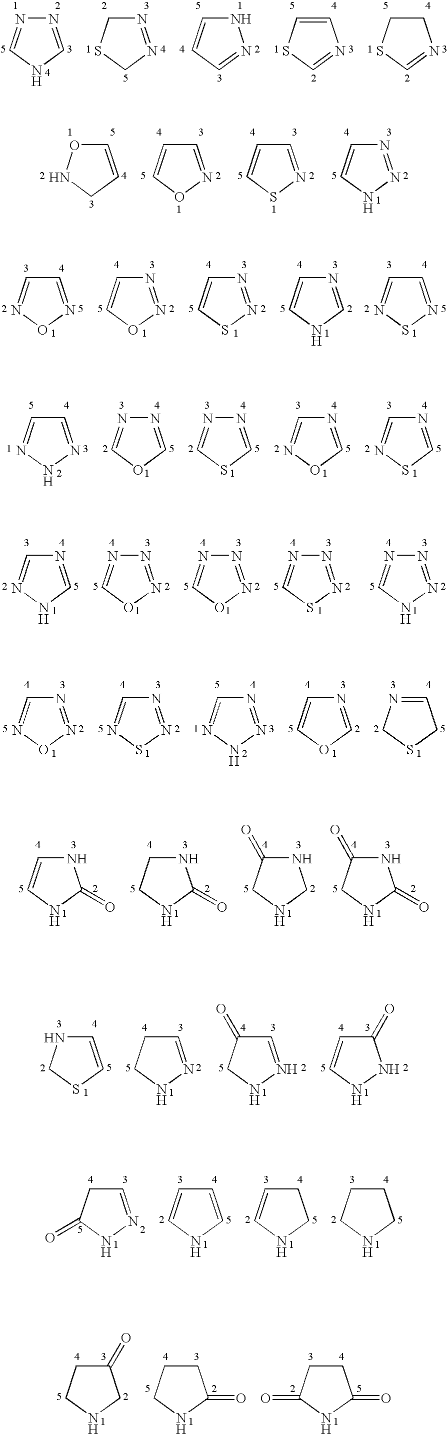

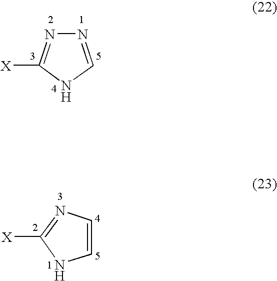

In the formulas, the substituent X is an alkyl group of 1 to 30 carbons, an aralkyl group of 7 to 20 carbons or an aryl group of 6 to 20 carbons, and is basically the same as the substituent A² in above formula (7).

Preferred examples of nitrogen six-membered rings include the following compounds. These too may have the various above-mentioned substituents, and may be hydrogenated or dehydrogenated.

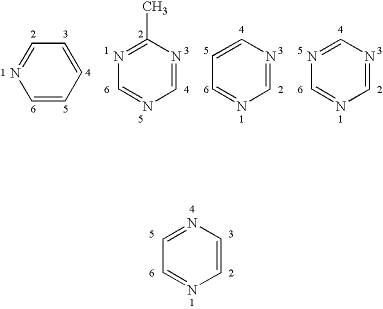

The above nitrogen heterocycles may also be used after fusion with a benzene ring or another nitrogen heterocycle. Preferred examples of such fused rings are shown below. These fused rings also may have the various above-mentioned substituents, and may be hydrogenated or dehydrated.

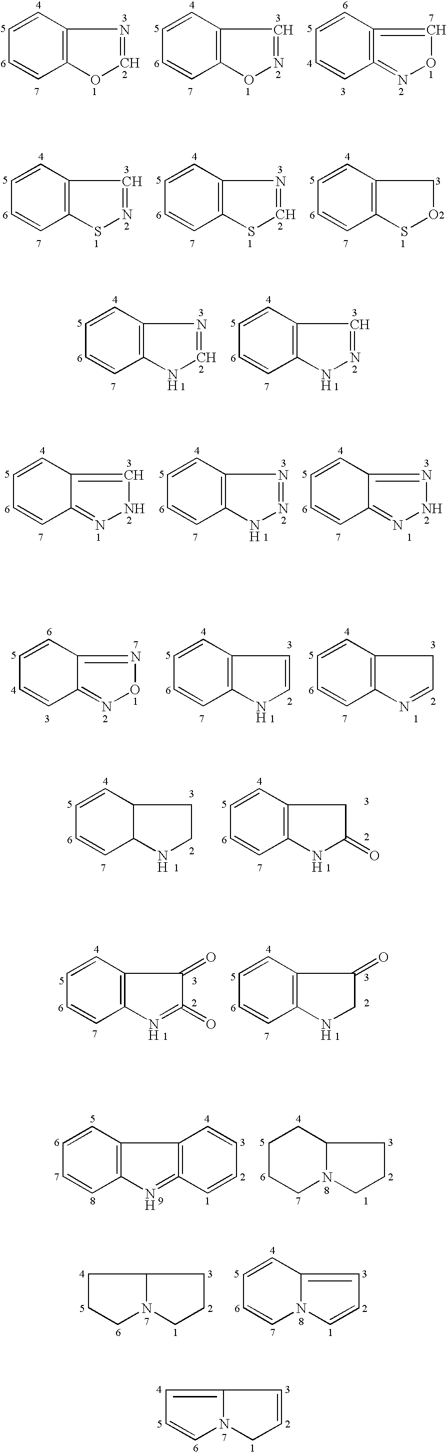

Of these nitrogen heterocycles, a triazole ring, a pyrazine ring, a thiadiazole ring and an imidazole ring are preferred because of the excellent recyclability, compression set, mechanical strength and hardness of the resulting thermoplastic elastomer (composition) of the third and fourth aspects.

If the thermoplastic elastomer of the third aspect has side chains containing the above nitrogen heterocycles, the nitrogen heterocycle-containing side chains are preferably side chains which include a structure of formula (10) below, and more preferably side chains which include a structure of formula (11) or (12) below that are bonded to the main chain at an α or β position.

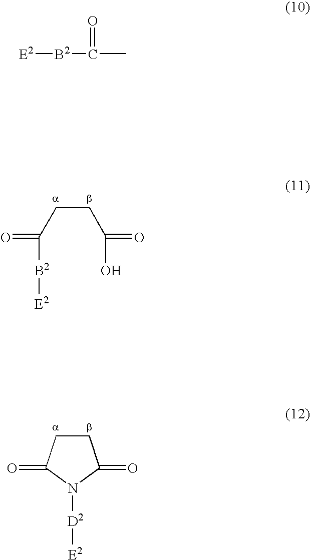

In the formula, E² is a nitrogen heterocycle, and B² and D² are each independently a single bond, an oxygen atom, the amino group NR′ (R′ being a hydrogen atom or an alkyl group of 1 to 10 carbons) or a sulfur atom, or an organic group which may include these atoms or group.

Here, the nitrogen heterocycle E² is exemplified by the nitrogen heterocycles mentioned above.

The substituents B² and D² are each independently basically the same as the substituent B² of above formula (7).

The substituent D² in above formula (12) is preferably a single bond or an alkylene or aralkylene group of 1 to 20 carbons which may include an oxygen atom, an amino group NR′ or a sulfur atom and which forms a conjugated system with the imide nitrogen. A single bond is most preferred. That is, together with the imide nitrogen in above formula (12), it is preferable to form an alkyleneamino or aralkyleneamino group of 1 to 20 carbons which may include an oxygen atom, an amino group NR′ or a sulfur atom. It is especially preferable to directly bond (single bond) the nitrogen heterocycle to the imide nitrogen in above formula (12).

If the thermoplastic elastomer of the third aspect has triazole ring- or imidazole ring-containing side chains as the above nitrogen heterocycle-containing side chains, these nitrogen heterocycle-containing side chains are preferably side chains which include a structure of formula (13), (14) or (15) below, and even more preferably side chains which include a structure of formula (16) or (17) below or of any one of formulas (18) to (21) below which is bonded to the main chain at an α or β position.

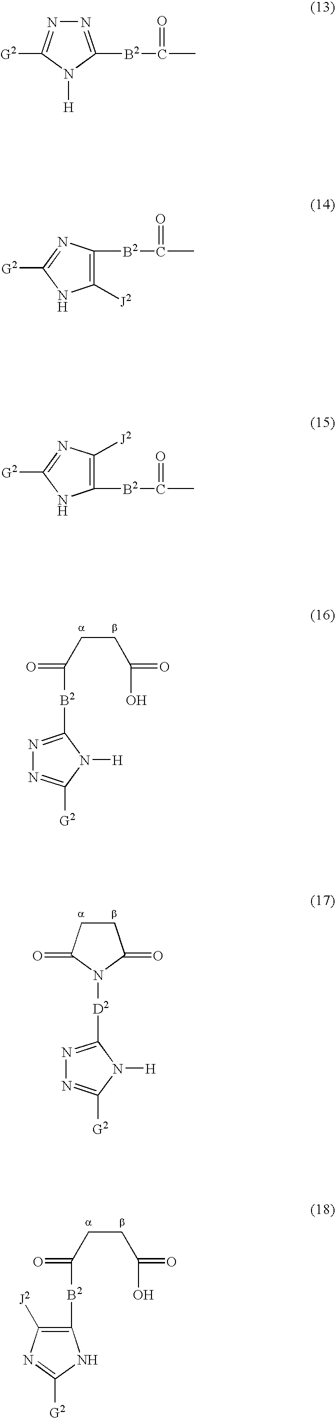

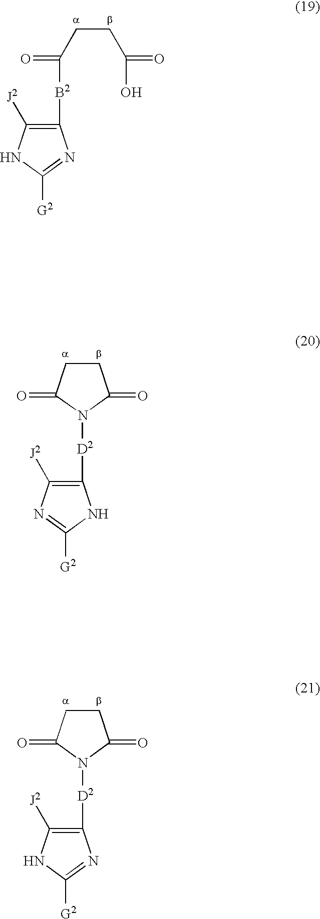

In these formulas, B² and D² are each independently a single bond, an oxygen atom, the amino group NR′ (R′ being a hydrogen atom or an alkyl group of 1 to 10 carbons) or a sulfur atom, or an organic group which may include these atoms or group; G² and J² are each independently a hydrogen atom, an alkyl group of 1 to 30 carbons, an aralkyl group of 7 to 20 carbons, or an aryl group of 6 to 20 carbons.

The substituents B² and D² are each independently basically the same as the substituents B² and D² in above formulas (10) to (12).

Specific examples of the substituents G² and J² include hydrogen atoms, and the following mentioned above as examples of substituent A² in formula (7): linear alkyl groups such as methyl, ethyl, propyl, butyl, pentyl, octyl, dodecyl and stearyl; branched alkyl groups such as isopropyl, isobutyl, s-butyl, t-butyl, isopentyl, neopentyl, t-pentyl, 1-methylbutyl, 1-methylheptyl and 2-ethylhexyl; aralkyl groups such as benzyl and phenethyl; and aryl groups such as phenyl, o-tolyl, m-tolyl, p-tolyl, dimethylphenyl and mesityl. G² and J² may each be like or unlike.

When the thermoplastic elastomer has side chains that include the above nitrogen heterocycles, it is preferable for these nitrogen heterocycle-containing side chains, together with the side chains having a structure of above formula (7) or above formula (8) or (9), to be introduced in a combined ratio (introduction ratio) per 100 mol % of the monomers making up the elastomeric polymer of 0.1 to 50 mol %. The relative introduction ratio between these side chains, defined as (nitrogen heterocycle-containing side chains)/(side chains containing a structure of above formula (7), (8) or (9)), is preferably 1/99 to 99/1, and even more preferable 10/90 to 90/10.

It is advantageous for the introduction ratio and the relative introduction ratio to be within these ranges because the above-mentioned properties of “a high tensile strength when crosslinked, excellent recyclability, and also good compression set” can be maintained, in addition to which the mechanical strength such as tensile strength can be further enhanced, and coloration of the thermoplastic elastomer (composition) owing to the nitrogen heterocycles that are introduced can be suppressed.

It is preferable for the thermoplastic elastomer of the third aspect to have a glass transition temperature of 25° C. or below. When the thermoplastic elastomer has two or more glass transition points or two or more thermoplastic elastomers are used together, it is preferable for at least one of the glass transition points to be 25° C. or less. If the glass transition point is 25° C. or less, molded parts made therefrom will exhibit a rubber elasticity at room temperature.

The method of preparing the thermoplastic elastomer of the third aspect according to a fifth aspect of the present invention (referred to below as simply “the preparation method of the fifth aspect”) is not subject to any particular limitation. An ordinary method may be selected, although it is preferable for this to be a preparation method which includes a reaction step (referred to below as simply “reaction step A”) in which a compound capable of introducing an imino group is reacted with an elastomeric polymer having cyclic acid anhydride group-containing side chains.

If the thermoplastic elastomer of the third aspect has the above-described nitrogen heterocycle-bearing side chains, the preparation method of the fifth aspect preferably includes above reaction step A and a reaction step in which a compound capable of introducing a nitrogen heterocycle is reacted with an elastomeric polymer having cyclic acid anhydride group-containing side chains (referred to below as simply “reaction step B”). This reaction step B may be included as a step carried out at the same time as reaction step A or as a step carried out before or after reaction step A, although inclusion as a step carried out before reaction step A is preferred.

Here, “elastomeric polymer having cyclic acid anhydride group-containing side chains” refers to an elastomeric polymer in which cyclic acid anhydride groups are stably bonded chemically (covalently bonded) to atoms which form the main chain, and which can be obtained by reacting the above-described elastomeric polymer with a compound capable of introducing a cyclic acid anhydride group.

Specific examples of the compound capable of introducing a cyclic acid anhydride group include cyclic acid anhydrides such as succinic anhydride, maleic anhydride, glutaric anhydride and phthalic anhydride.

The elastomeric polymer having cyclic acid anhydride groups-containing side chains may be prepared by a commonly used method, such as a method in which a cyclic acid anhydride is graft polymerized onto the above-described elastomeric polymer under ordinary conditions, e.g., stirring under the application of heat. Alternatively, a commercial product may be used.

Examples of commercial products include those mentioned as examples of “carbonyl-containing group-modified elastomers” in the above description of the method for preparing thermoplastic elastomers of the first aspect.

The compound capable of introducing an imino group is not subject to any particular limitation, provided it is a compound having on the molecule an imino group which is not part of a cyclic compound such as a heterocycle and having other active hydrogen groups (e.g., hydroxyl, thiol, amino). Specific examples include alkylamino alcohols such as N-methylaminoethanol, N-ethylaminoethanol, N-n-propylaminoethanol, N-n-butylaminoethanol, N-n-pentylaminoethanol, N-n-hexylaminoethanol, N-n-heptylaminoethanol, N-n-octylaminoethanol, N-n-nonylaminoethanol, N-n-decylaminoethanol, N-n-undecylaminoethanol, N-n-dodecylaminoethanol, N-(2-ethylhexyl)aminoethanol, N-methylaminopropanol and N-methylaminobutanol; aromatic amino alcohols such as N-phenylaminoethanol, N-toluylaminoethanol, N-phenylaminopropanol and N-phenylaminobutanol; alkylaminothiols such as N-methylaminoethanethiol, N-ethylaminoethanethiol, N-n-propylaminoethanethiol, N-n-butylaminoethanethiol, N-methylaminopropanethiol and N-methylaminobutanethiol; aromatic aminothiols such as N-phenylaminoethanethiol, N-toluylaminoethanethiol, N-phenylaminopropanethiol and N-phenylaminobutanethiol; alkyldiamines such as N-methylethylenediamine, N-ethylethylenediamine, N-n-propylethylenediamine, N-methylpropanediamine, N-ethylpropanediamine, N-methylbutanediamine, N,N′-dimethylethylenediamine and N,N′-diethylethylenediamine; and aromatic diamines such as N-phenylethylenediamine, N-phenylpropanediamine, N-phenylbutanediamine and N,N′-diphenylethylenediamine.

Of these, N-n-butylaminoethanol, N-n-octylaminoethanol and N-n-dodecylaminoethanol are preferred.

Previously mentioned reaction step A is a step in which the compound capable of introducing an imino group and the elastomeric polymer having cyclic acid anhydride group-containing side chains are mixed and reacted (ring opening of the cyclic acid anhydride group) at a temperature at which the compound and the cyclic acid anhydride groups can chemically bond (e.g., 80 to 200° C.). This reaction provides the resulting thermoplastic elastomer of the third aspect with structures of above formula (8) or (9) on the side chains thereof.

The compound capable of introducing an imino group may be reacted with some or all of the cyclic acid anhydride groups present on the side chains of the elastomeric polymer. Here, “some” is preferably at least 1 mol %, more preferably at least 50 mol %, and most preferably at least 80 mol %, per 100 mol % of the cyclic acid anhydride groups. Within this range, sufficiently high physical properties (e.g., the properties at break) are manifested. Reaction of the compound capable of introducing an imino group with all (100 mol %) of the cyclic acid anhydride groups is especially preferred for achieving an excellent compression set.

The compound capable of introducing a nitrogen heterocycle may be any of the nitrogen heterocycles mentioned above or may be a nitrogen heterocycle having a substituent (e.g., hydroxyl group, thiol group, amino group) which reacts with a cyclic acid anhydride group such as that of maleic anhydride.

Previously mentioned reaction step B is a step in which a compound capable of introducing a nitrogen heterocycle is mixed with the above-described elastomeric polymer having cyclic acid anhydride group-containing side chains, and the compound and the cyclic acid anhydride groups are reacted (ring opening of cyclic acid anhydride group) at a chemically bondable temperature (e.g., 80 to 200° C.). By means of this reaction, structures of above formula (11) or (12) are incorporated onto side chains of the resulting thermoplastic elastomer of the third aspect.

Reaction step B is necessary when the thermoplastic elastomer of the third aspect has nitrogen heterocycle-containing side chains and, as noted above, is preferably carried out before reaction step A. In this case, it suffices to react the compound capable of introducing a nitrogen heterocycle with some of the cyclic acid anhydride groups contained on the elastomeric polymer side chains. Here, “some” is preferably 1 to 99 mol %, more preferably 1 to 90 mol %, and even more preferably 50 to 90 mol %, per 100 mol % of the cyclic acid anhydride groups. Within this range, the introduction of the nitrogen heterocycles has a discernible effect, and the mechanical strength (e.g., tensile strength) when the thermoplastic elastomer is crosslinked increases.

In the above preparation method, each group (structure) on the side chains of the thermoplastic elastomer, that is, the unreacted cyclic acid anhydride groups and the structures represented by formulas (8), (9), (11) and (12) above, can be confirmed by a commonly used analytic techniques such as NMR and IR spectroscopy.

The thermoplastic elastomer of the third aspect is now described with regard to the nitrogen heterocycle bonding positions when it has nitrogen heterocycle-containing side chains. For the sake of convenience, “nitrogen heterocycle” is defined here as “a nitrogen-containing n-membered ring compound (n≧3).”

The bonding positions described below (“the 1 to n positions”) are based on IUPAC nomenclature. For example, in a compound having three nitrogen atoms with unshared electron pairs, the bond positions are set in an order based on IUPAC nomenclature. The bond positions are specifically denoted in the examples of five-membered ring, six-membered ring and fused ring-type nitrogen heterocycles shown above.

In the thermoplastic elastomer of the third aspect, the bonding position of the nitrogen-containing n-membered ring compound that bonds directly with or through an organic group to the copolymer is not subject to any particular limitation, and may be any bonding position (position 1 to n). Bonding at position 1 or at position 3 to position n is preferred.

When one nitrogen atom is included in the nitrogen-containing n-membered ring compound (e.g., a pyridine ring), bonding at the 3 position to the (n-1) position is preferred because a chelate readily forms within the molecule, endowing compositions prepared therefrom with excellent physical properties such as tensile strength.

Through selection of the bonding position of the nitrogen-containing n-membered ring compound, the thermoplastic elastomer can be made to readily form crosslinks by means of, for example, hydrogen bonds, ionic bonds and coordination bonds between the molecules of thermoplastic elastomer, and will thus have excellent recyclability and excellent mechanical strength.

Next, the thermoplastic elastomer composition of the second aspect and the thermoplastic elastomer composition of the fourth aspect are described. Where an explanation that distinguishes between these compositions is not necessary below, they will be referred to collectively as “the thermoplastic elastomer composition of the present invention.” Similarly, where an explanation that distinguishes between the thermoplastic elastomer of the first aspect and the thermoplastic elastomer of the third aspect is not necessary below, they will be referred to collectively as “the thermoplastic elastomer of the present invention.”

As mentioned above, the thermoplastic elastomer composition of the second aspect of the present invention is a thermoplastic elastomer composition which includes the thermoplastic elastomer of the first aspect.

As mentioned above, the thermoplastic elastomer composition of the fourth aspect of the present invention is a thermoplastic elastomer composition which includes the thermoplastic elastomer of the third aspect.

The thermoplastic elastomer composition of the present invention may include only one type, or may include two or more types, of the thermoplastic elastomer of the present invention. If two or more types are included, the thermoplastic elastomers may be used in any mixing ratio depending on such considerations as the intended use of the thermoplastic elastomer composition of the present invention and the physical properties required of this thermoplastic elastomer composition.

In addition to the thermoplastic elastomer of the present invention, the thermoplastic elastomer composition of the present invention preferably includes also carbon black and/or silica as a reinforcement.

The type of carbon black may be suitably selected according to the intended application. Carbon blacks are generally divided on the basis of particle size into hard carbon and soft carbon. Soft carbon has a low reinforcing effect on rubber, and hard carbon has a high reinforcing effect on rubber. In the present invention, the use of hard carbon having a high reinforcing effect is preferred.

The carbon black content (when carbon black alone is used) per 100 parts by weight of the thermoplastic elastomer of the present invention is 1 to 200 parts by weight, preferably 10 to 100 parts by weight, and more preferably 20 to 80 parts by weight.

The silica is not subject to any particular limitation. Specific examples include fumed silica, fired silica, precipitated silica, pulverized silica, fused silica and diatomaceous earth. The silica content (when silica alone is used) per 100 parts by weight of the thermoplastic elastomer of the present invention is 1 to 200 parts by weight, preferably 10 to 100 parts by weight, and more preferably 20 to 80 parts by weight. Of these, precipitated silica is preferred.

If silica is used as a reinforcement, a silane coupling agent may also be used. Illustrative examples of silane coupling agents include bis(triethoxysilylpropyl)tetrasulfide (Si69), bis(triethoxysilylpropyl)disulfide (Si75), γ-mercaptopropyltrimethoxysilane and vinyltrimethoxysilane. Use can also be made of the subsequently mentioned aminosilane compounds.

When both carbon black and silica are used, their content (combined amount of carbon black and silica) per 100 parts by weight of the thermoplastic elastomer of the present invention is 1 to 200 parts by weight, preferably 10 to 100 parts by weight, and more preferably 20 to 80 parts by weight.

If necessary, the thermoplastic elastomer composition of the present invention may include also, within a range that does not compromise the objects of the present invention, various types of additives such as polymers other than the thermoplastic elastomer of the present invention, reinforcements (fillers) other than carbon black and silica, fillers on which an amino group has been introduced (referred to below as simply “aminated fillers”), amino group-bearing compounds other than such aminated fillers, metal atom-containing compounds (referred to below as simply “metal salts”), maleic anhydride-modified polymers, age resisters, antioxidants, pigments (dyes), plasticizers, thixotropic agents, ultraviolet absorbers, fire retardants, solvents, surfactants (including leveling agents), dispersants, dehydrating agents, rust inhibitors, tackifiers, antistatic agents and fillers.

These various types of additives may be commonly used substances. Specific, non-limiting, examples of such additives are given below.

The polymer other than the thermoplastic elastomer of the present invention is preferably a polymer which, for the same reason as that given above, has a glass transition temperature of 25° C. or below, and is most preferably a polymer from among those which may be used as the main chain of the thermoplastic elastomer of the present invention. Specific examples include natural rubber (NR), isoprene rubber (IR), butadiene rubber (BR), 1,2-butadiene rubber, styrene-butadiene rubber (SBR), acrylonitrile-butadiene rubber (NBR), butyl rubber (IIR), ethylene-propylene-diene rubber (EPDM), ethylene-propylene rubber (EPM), ethylene-acrylic rubber (AEM) and ethylene-butene rubber (EBM). Especially preferred examples include polymers without unsaturated bonds, such as IIR, EPM and EBM, and polymers having few unsaturated bonds (e.g., EPDM). Polymers having hydrogen-bondable sites are also preferred. Examples include polyesters, polylactones and polyamides.

In the practice of the present invention, one or more polymer other than the thermoplastic elastomer of the present invention may be included, the content of such polymers per 100 parts by weight of the thermoplastic elastomer of the present invention being preferably from 0.1 to 100 parts by weight, and more preferably from 1 to 50 parts by weight.

Specific examples of reinforcements other than carbon black and silica include iron oxide, zinc oxide, aluminum oxide, titanium oxide, barium oxide, magnesium oxide, calcium carbonate, magnesium carbonate, zinc carbonate, agalmatolite clay, kaolin clay and fired clay. The content of these reinforcements per 100 parts by weight of the thermoplastic elastomer of the present invention is preferably 10 to 100 parts by weight, and more preferably 20 to 80 parts by weight.

The filler which serves as the base of the aminated filler (sometimes referred to below as simply the “base filler”) is exemplified by the fillers mentioned above as capable of being added, if desired, to the crosslinked rubber. From the standpoint of such considerations as the ease of introducing the amino groups and the ease of adjusting the ratio in which amino groups are introduced (introduction ratio), silica, carbon black and calcium carbonate are preferred. Silica is especially preferred.

The amino groups introduced onto the base filler (sometimes referred to below as simply the “amino groups”) are not subject to any particular limitation. Specific examples include aliphatic amino groups, aromatic amino groups, heterocyclic amino groups, and mixed amino groups composed of a plurality of these amino groups.

Here, “aliphatic amino groups” refers to amino groups on aliphatic amine compounds, “aromatic amino groups” refers to amino groups bonded to aromatic groups on aromatic amine compounds, and “heterocyclic amino groups” refers to amino groups on heterocyclic amine compounds.

Of these, to suitably form interactions with the thermoplastic elastomer of the present invention and enable effective dispersion within the thermoplastic elastomer, heterocyclic amino groups, mixed amino groups which include heterocyclic amino groups, or aliphatic amino groups are preferred. Heterocyclic amino groups or aliphatic amino groups are preferred.

The amino group may be a primary (—NH₂), secondary (imino group, >NH), tertiary (>N—) or quaternary (>N⁺<) amino group.

If the amino groups are primary amino groups, they will tend to have strong interactions with the thermoplastic elastomer of the present invention, which may result in gelation depending on the conditions when the composition is prepared. On the other hand, if the amino groups are tertiary amino groups, they will tend to have weak interactions with the thermoplastic elastomer of the present invention, as a result of which the improvement in compression set and other properties of the composition prepared therewith may be small.

For these reasons, the amino groups are preferably primary or secondary amino groups, and most preferably secondary amino groups.

That is, the above amino groups are preferably heterocyclic amino groups, heterocyclic amino group-containing mixed amino groups or primary or secondary aliphatic amino groups, and most preferably heterocyclic amino groups or primary or secondary aliphatic amino groups.

It is desirable for the base filler to have at least one amino group on the surface thereof, although having a plurality of amino groups is preferable for achieving a good improvement in properties such as the compression set in compositions prepared therefrom.

If the base filler has a plurality of amino groups on the surface, it is preferable for at least one of the amino groups to be a heterocyclic amino group, and even more preferable for a primary or secondary amino group (aliphatic amino group, aromatic amino group, heterocyclic amino group) to also be included.

The type and class of the amino group can be suitably adjusted according to the physical properties required of the composition.

The above-described aminated filler is obtained by introducing the amino group onto the base filler.

The method of introducing the amino group, while not subject to any particular limitation, is exemplified by surface treatment processes commonly used for various types of fillers and reinforcements (e.g., surface modification processes and surface coating processes). Preferred methods include a method that involves reacting the filler with a compound having both a functional group capable of reacting with the base filler and an amino group (surface modification process), a method in which the surface of the base filler is coated with an amino group-bearing polymer (surface coating process), or a method that involves the reaction of an amino group-bearing compound, for instance, in a filler synthesis operation.

A single aminated filler may be used alone, or two or more may be used together. The mixing ratio when two or more are used together can be set to any ratio depending on such considerations as the intended use of the thermoplastic elastomer composition and the physical properties required of the thermoplastic elastomer composition of the present invention.

The content of the aminated filler per 100 parts by weight of the thermoplastic elastomer of the present invention is preferably 1 to 200 parts by weight, more preferably at least 10 parts by weight, and most preferably at least 30 parts by weight.

The amino group-bearing compounds other than the above aminated fillers are now described.

The amino groups on these amino group-bearing compounds are basically the same as those described above for the aminated filler. Moreover, the number of amino groups included on such a compound is not subject to any particular limitation so long as it is at least one. However, it is preferable for the number of amino groups to be two or more, because two or more crosslinks can thus be formed with the thermoplastic elastomer of the present invention, providing an excellent physical property improving effect.

As with the amino group in the above-described aminated filler, the amino group in the amino group-bearing compound is not limited to any particular class and may be a primary (—NH₂), secondary (imino group, >NH), tertiary (>N—) or quaternary (>N⁺<) amino group. Any type of amino group may be selected in accordance with the recyclability and physical properties (e.g., compression set, mechanical strength and hardness) required of the thermoplastic elastomer composition of the present invention. Selecting a secondary amino group tends to result in an excellent mechanical strength, and selecting a tertiary amino group tends to result in an excellent recyclability. In particular, if there are two secondary amino groups, the resulting thermoplastic elastomer composition of the present invention will have an excellent recyclability and compression set, with both of these qualities being in a good balance.

When the amino group-bearing compound has two or more amino groups, the number of primary amino groups on the amino group-bearing compound is preferably two or less, and more preferably one or less. The presence of three or more primary amino groups will result in the formation of strong (crosslink) bonds between these amino groups and functional groups (particularly carboxyl groups that are carbonyl-containing groups) on the thermoplastic elastomer of the present invention, which may compromise the excellent recyclability.

That is, the class and number of amino groups and the structure of the amino group-bearing compound can be suitably selected and adjusted while taking into account, for example, the bonding forces between functional groups on the thermoplastic elastomer of the present invention and the amino groups on the above amino group-bearing compound.

Specific examples of such amino group-bearing compounds include secondary aliphatic diamines such as N,N′-dimethylethylenediamine, N,N′-diethylethylenediamine, N,N′-diisopropylethylenediamine, N,N′-dimethyl-1,3-propanediamine, N,N′-diethyl-1,3-propanediamine, N,N′-diisopropyl-1,3-propanediamine, N,N′-dimethyl-1,6-hexanediamine, N,N′-diethyl-1,6-hexanediamine and N,N′,N″-trimethylbis(hexamethylene)triamine; tertiary aliphatic diamines such as tetramethyl-1,6-hexanediamine; polyamines containing an aromatic primary amine and a heterocyclic amine, such as aminotriazole and aminopyridine; linear alkyl monoamines such as dodecylamine; and tertiary heterocyclic diamines such as dipyridyl. These compounds are preferred because they greatly improve such properties as compression set and mechanical strength.

Of these, secondary aliphatic diamines, polyamines containing an aromatic primary amine and a heterocyclic amine, and tertiary heterocyclic diamines are more preferred.

In addition to the above, amino group-bearing compounds that can be used include amino group-bearing polymeric compounds.

Specific, non-limiting examples of amino group-bearing polymeric compounds include polymers such as polyamides, polyurethanes, urea resins, melamine resins, polyvinylamines, polyallylamines, polyacrylamides, polymethacrylamides, polyaminostyrenes, and amino group-bearing polysiloxanes; and also polymers obtained by modifying various types of polymers with amino group-bearing compounds.

The characteristics such as average molecular weight, molecular weight distribution and viscosity of these polymers are not subject to any particular limitation and may be set as appropriate for the intended use of the thermoplastic elastomer composition of the present invention and the physical properties required of the thermoplastic elastomer composition of the present invention.

The amino group-bearing polymeric compound is preferably a polymer obtained by polymerizing (polyaddition, polycondensation) a condensable or polymerizable compound (monomer) having an amino group. For ready availability, ease of preparation, and ease of controlling the molecular weight and the introduction ratio of amino groups, it is more preferably an amino group-bearing polysiloxane which is the homocondensation product of a silyl compound having a hydrolyzable substituent and an amino group or the co-condensation product of such a silyl compound and a silyl compound having no amino group.

Specific, non-limiting examples of the silyl compound having a hydrolyzable substituent and an amino group include aminosilane compounds having an aliphatic primary amino group, such as γ-aminopropyltrimethoxysilane, γ-aminopropyltriethoxysilane, γ-aminopropylmethyldimethoxysilane, γ-aminopropylmethyldiethoxysilane and 4-amino-3,3-dimethylbutyltrimethoxysilane (all produced by Nippon Unicar Co., Ltd.); aminosilane compounds, and more specifically aminosilane compounds having an aliphatic secondary amino group, such as N,N-bis[(3-trimethoxysilyl)propyl]amine, N,N-bis[(3-triethoxysilyl)propyl]amine, N,N-bis[(3-tripropoxysilyl)propyl]amine (all produced by Nippon Unicar Co., Ltd.), 3-(n-butylamino)propyltrimethoxysilane (Dynasilane 1189, produced by Degussa-Hülls) and N-ethylaminoisobutyltrimethoxysilane (Silquest A-Link 15 silane, produced by OSi Specialties, Inc.); aminosilane compounds having aliphatic primary and secondary amino groups, such as N-β-(aminoethyl)-γ-aminopropylmethyldimethoxysilane, N-β-(aminoethyl)-γ-aminopropyltrimethoxysilane and N-β-(aminoethyl-γ-aminopropyltriethoxysilane (produced by Nippon Unicar Co., Ltd.); aminosilane compounds having an aromatic secondary amino group, such as N-phenyl-γ-aminopropyltrimethoxysilane (Nippon Unicar Co., Ltd.); and aminosilane compounds having heterocyclic amino groups, such as imidazoletrimethoxysilane (Japan Energy Corp.), and triazolesilanes obtained by reacting an aminotriazole with an epoxysilane compound or an isocyanate silane compound in the presence or absence of a catalyst and at or above room temperature.

Of these, from the standpoint of high improvement effects on physical properties such as compression set, the following aminoalkylsilane compounds are preferred: aminosilane compounds having an aliphatic primary amino group, aminosilane compounds having an aliphatic secondary amino group, and aminosilane compounds having both aliphatic primary and secondary amino groups.

The silyl compound having no amino group is not subject to any particular limitation, provided it is a different compound from the silyl compound having a hydrolyzable substituent and an amino group and is a compound which has no amino group. Examples include alkoxysilane compounds and halogenated silane compounds. Of these, alkoxysilane compounds are preferred on account of their ready availability, ease of handling, and the excellent physical properties of the co-condensation product obtained.

Specific examples of the alkoxysilane compound include tetramethoxysilane, tetraethoxysilane, tetrabutoxysilane, tetraisopropoxysilane, methyltrimethoxysilane, methyltriethoxysilane, methyltributoxysilane, methyltriisopropoxysilane, phenyltrimethoxysilane and dimethyldimethoxysilane.

Specific examples of the halogenated silane compound include tetrachlorosilane and vinyltrifluorosilane.

Of these, tetraethoxysilane and tetramethoxysilane are preferred because they are inexpensive and safe to handle.

The silyl compound having a hydrolyzable substituent and an amino group and the silyl compound having no amino group may each be used singly or as a combination of two or more thereof.

Such amino group-bearing polymeric compounds may be used singly or as a combination of two or more thereof. When two or more are used together, the mixing ratio therebetween may be set to any value based on such considerations as the intended use of the thermoplastic elastomer composition of the present invention and the physical properties required of the thermoplastic elastomer composition of the present invention.

As with the amino group-bearing compound described above, the content of the amino group-bearing polymeric compound can be specified in terms of the number of nitrogen atoms (equivalents) on the compound with respect to the side chains on the thermoplastic elastomer of the present invention. However, sometimes there are amino groups present which cannot be made to effectively interact with the thermoplastic elastomer on account of such factors as the structure or molecular weight of the polymer compound.

Therefore, the content of the amino group-bearing polymeric compound per 100 parts by weight of the thermoplastic elastomer of the present invention is preferably 1 to 200 parts by weight, more preferably at least 5 parts by weight, and most preferably at least 10 parts by weight.

The metal salt is not subject to any particular limitation so long as it is a compound containing at least one metal element. A compound containing one or more metal element selected from the group consisting of lithium, sodium, potassium, titanium, vanadium, chromium, manganese, iron, cobalt, nickel, copper, zinc, gallium and aluminum is preferred.

Specific examples of the metal salts include any of the following which contain one or more of these metal elements: saturated fatty acid salts having 1 to 20 carbons (e.g., formates, acetates, stearates), unsaturated aliphatic acid salts such as (meth)acrylates, metal alkoxides (reaction products with alcohols having 1 to 12 carbons), nitrates, carbonates, bicarbonates, chlorides, oxides, hydroxides and complexes with diketones.

Here, “complexes with diketones” refers to complexes in which 1,3-diketone (e.g., acetylacetone) ligands coordinate to a metal atom.

Of the above, to better improve the compression set of the resulting inventive thermoplastic elastomer composition, the metal element is preferably titanium, aluminum or zinc, and the metal salt is preferably a saturated fatty acid salt having 1 to 20 carbons (e.g., acetate, stearate), a metal alkoxide (reaction product with an alcohol having 1 to 12 carbons), an oxide, a hydroxide, or a complex with a diketone, and most preferably a saturated fatty acid salt having 1 to 20 carbons such as stearate, a metal alkoxide (reaction product with an alcohol having 1 to 12 carbons, or a complex with a diketone.

The metal salt may be used singly or as a combination of two or more thereof. When two or more are used together, the mixing ratio therebetween may be set to any value according to such considerations as the intended use of the thermoplastic elastomer composition of the present invention and the physical properties required of the thermoplastic elastomer composition of the present invention.

The content of the metal salt, based on the carbonyl groups present on the thermoplastic elastomer of the present invention, is preferably 0.05 to 3.0 equivalents, more preferably 0.1 to 2.0 equivalents, and most preferably 0.2 to 1.0 equivalent. A metal salt content within this range is preferable for improving the physical properties, such as the compression set, mechanical strength and hardness, of the resulting inventive thermoplastic elastomer composition.

Any hydroxide, metal alkoxide, carboxylate or other suitable salt capable of taking up the metal can be used as the above metal salt. In the case of hydroxides, for example, if the metal is iron, Fe(OH)₂ and Fe(OH)₃ may be used alone or in admixture.

As noted above, the metal salt is preferably a compound which includes one or more metal element selected from the group consisting of lithium, sodium, potassium, titanium, vanadium, chromium, manganese, iron, cobalt, nickel, copper, zinc, gallium and aluminum. However, other metal elements may also be included, insofar as the effects of the present invention are not compromised. The content of such other metal elements, while not subject to any particular limitation, is preferably from 1 to 50 mol % with respect to the total metal elements within the metal salt.

The maleic anhydride-modified polymer mentioned above is a polymer obtained by modifying the above-described elastomeric polymer with maleic anhydride. The side chains of the maleic anhydride-modified polymer may have maleic anhydride residues and functional groups other than nitrogen heterocycles, although they preferably have only maleic anhydride residues.

The maleic anhydride residues are introduced (modification) onto the side chains or ends of the above-described elastomeric polymer; they are not introduced onto the main chain of the elastomeric polymer. Moreover, the maleic anhydride residues are cyclic acid anhydride groups, and ring opening of these cyclic acid anhydride groups (moieties) does not occur.

Accordingly, the maleic anhydride-modified thermoplastic polymer is exemplified, as shown in formula (24) below, by a thermoplastic elastomer having cyclic acid anhydride groups on side chains and lacking nitrogen heterocycles which can be obtained by reacting the ethylene unsaturated bond portion of maleic anhydride with the elastomeric polymer. A specific example is an elastomeric polymer having the above-described cyclic acid anhydride groups on side chains.

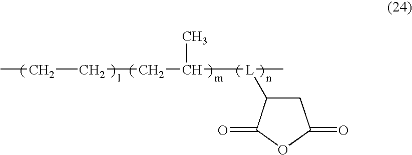

In the formula, L is an ethylene residue or a propylene residue, and the letters l, m and n are each independently a number from 0.1 to 80.

To enable the compression set to be improved without compromising the excellent recyclability, the amount of maleic anhydride modification is preferably from 0.1 to 50%, more preferably from 0.3 to 30 mol %, and most preferably from 0.5 to 10 mol %, per 100 mol % of the main chain of the elastomeric polymer.

The maleic anhydride-modified polymer may be used alone or as a combination of two or more thereof. When two or more are used together, the mixing ratio therebetween may be set to any value in accordance with such considerations as the intended use of the thermoplastic elastomer composition of the present invention and the physical properties required of the thermoplastic elastomer composition of the present invention.

The content of the maleic anhydride-modified polymer per 100 parts by weight of the thermoplastic elastomer of the present invention is preferably 1 to 100 parts by weight, and more preferably 5 to 50 parts by weight. A maleic anhydride-modified polymer content within this range is preferable because the processability and mechanical strength of the resulting thermoplastic elastomer composition of the present invention are improved.

During production of the thermoplastic elastomer of the present invention, if some of the elastomeric polymer bearing cyclic acid anhydride groups on side chains remains as unreacted product in above-described reaction step A or B, instead of removing the remaining carbonyl-containing group-modified elastomer, this elastomer may be left as it is within the thermoplastic elastomer composition of the present invention.

Specific examples of age resisters include hindered phenol compounds and aliphatic or aromatic hindered amine compounds.

Specific examples of antioxidants include butyl hydroxytoluene (BHT) and butyl hydroxyanisole (BHA).

Specific examples of the pigment include inorganic pigments such as titanium dioxide, zinc oxide, ultramarine, red iron oxide, lithopone, lead, cadmium, iron, cobalt, aluminum, hydrochlorides and sulfates; and organic pigments such as azo pigments and copper phthalocyanine pigments.

Specific examples of plasticizers include derivatives of benzoic acid, phthalic acid, trimellitic acid, pyromellitic acid, adipic acid, sebacic acid, fumaric acid, maleic acid, itaconic acid and citric acid; and also polyesters, polyethers and epoxy compounds.

Specific examples of thixotropic agents include bentonite, silicic acid anhydride, silicic acid derivatives and urea derivatives.

Specific examples of ultraviolet absorbers include those based on 2-hydroxybenzophenone, benzotriazole, or salicylic acid esters.

Specific examples of fire retardants include phosphorus-based compounds such as TCP, halogen-based compounds such as chlorinated paraffins and perchloropentacyclodecane, antimony-based compounds such as antimony oxide, and aluminum hydroxide.

Specific examples of solvents include hydrocarbon solvents such as hexane and toluene, halogenated hydrocarbons such as tetrachloromethane, ketones such as acetone and methyl ethyl ketone, ethers such as diethyl ether and tetrahydrofuran, and esters such as ethyl acetate.

Specific examples of surfactants (leveling agents) include polybutyl acrylate, polydimethylsiloxane, modified silicone compounds and fluorocarbon surfactants.

A specific example of the dehydrating agent is vinyl silane.

Specific examples of the rust inhibitors include zinc phosphate, tannic acid derivatives, phosphoric acid esters, basic sulfonic acid salts and various types of rust-inhibiting pigments.

Illustrative examples of tackifiers include known silane coupling agents, silane compounds having alkoxysilyl groups, titanium coupling agents, and zirconium coupling agents. Specific examples include trimethoxyvinylsilane, vinyltriethoxysilane, vinyltris(2-methoxyethoxy)silane, γ-methacryloxypropyltrimethoxysilane and 3-glycidoxypropyltrimethoxysilane.

General examples of antistatic agents include quaternary ammonium salts and hydrophilic compounds such as polyglycols and ethylene oxide derivatives.

The plasticizer content per 100 parts by weight of the thermoplastic elastomer of the present invention is preferably 1 to 50 parts by weight, and more preferably 1 to 30 parts by weight. The content of the other additives per 100 parts by weight of the thermoplastic elastomer of the present invention is preferably 0.1 to 10 parts by weight, and more preferably 1 to 5 parts by weight.

The thermoplastic elastomer of the present invention may be one that is self-crosslinking. However, if necessary, compounds such as vulcanizing agents, accelerator activator, vulcanization accelerators and vulcanization retarders can also be used insofar as the objects of the present invention are attainable.

Exemplary vulcanizing agents include sulfur-based vulcanizing agents, organic peroxide-type vulcanizing agents, metal oxide-type vulcanizing agents, phenolic resins and quinone dioxime.

Specific examples of sulfur-based vulcanizing agents include sulfur powder, precipitated sulfur, highly dispersible sulfur, surface-treated sulfur, insoluble sulfur, dimorpholine disulfide and alkylphenol disulfides.

Specific examples of organic peroxide-type vulcanizing agents include benzoyl peroxide, t-butyl hydroperoxide, 2,4-dichlorobenzoyl peroxide, 2,5-dimethyl-2,5-di(t-butylperoxy)hexane and 2,5-dimethylhexane-2,5-di(peroxybenzoate).

Additional examples include magnesium oxide, litharge (lead oxide), p-quinone dioxime, tetrachloro-p-benzoquinone, p-dibenzoylquinone dioxime, poly-p-dinitrosobenzene and methylene dianiline.

Specific examples of vulcanizing aids include zinc oxide, magnesium oxide, amines; fatty acids such as acetic acid, propionic acid, butanoic acid, stearic acid, acrylic acid and maleic acid; and zinc salts of fatty acids, such as zinc acetate, zinc propionate, zinc butanoate, zinc stearate, zinc acrylate and zinc maleate.

Specific examples of vulcanization accelerators include thiuram compounds such as tetramethylthiuram disulfide (TMTD) and tetraethylthiuram disulfide (TETD); aldehyde ammonia compounds such as hexamethylenetetramine; guanidine compounds such as diphenylguanidine; thiazole compounds such as 2-mercaptobenzothiazole and dibenzothiazyl disulfide (DM); and sulfenamide compounds such as N-cyclohexyl-2-benzothiazyl sulfenamide and N-t-butyl-2-benzothiazyl sulfenamide. Use can also be made of alkylphenol resins and halogenated alkylphenol resins.

Specific examples of vulcanization retarders include organic acids such as phthalic anhydride, benzoic acid, salicylic acid and acetylsalicylic acid; nitroso compounds such as polymers of N-nitrosodiphenylamine, N-nitrosophenyl-β-naphthylamine and N-nitrosotrimethyldihydroquinoline; halogenated compounds such as trichloromelanine; 2-mercaptobenzimidazole; and N-(cyclohexylthio)phthalimide (Santogard PVI).

The content of these vulcanizing agents per 100 parts by weight of the thermoplastic elastomer of the present invention is preferably from 0.1 to 20 parts by weight, and more preferably from 1 to 10 parts by weight.

The thermoplastic elastomer composition of the present invention can be prepared by using a known process in which the above-described additives are added, as needed, to the thermoplastic elastomer of the present invention.

More specifically, the method of preparation is exemplified by using a mixing apparatus (e.g., a roll mill, kneader, universal agitator, twin-screw kneading extruder, Banbury mixer) to masticate the thermoplastic elastomer of the present invention and the various above additives which may be optionally included.

The curing conditions when the thermoplastic elastomer composition of the present invention is permanently crosslinked (with a vulcanizing agent) can be suitably selected according to the various ingredients to be blended and are not subject to any particular limitation. For example, curing conditions that involve curing at a temperature of 130 to 200° C. for 5 to 30 minutes are preferred.

The thermoplastic elastomer and thermoplastic elastomer composition of the present invention (these are referred to collectively below as the “thermoplastic elastomer (composition) of the present invention”), when heated to 80 to 300° C., undergo dissociation of the three-dimensional crosslinks (crosslink structures) and soften, and are thus imparted with flow properties. This is presumably due to the weakening of interactions between side chains that have formed intermolecularly or intramolecularly.

When the thermoplastic elastomer (composition) of the present invention that has been softened and imparted with flow properties is left to stand at about 80° C. or below, the dissociated three-dimensional crosslinks (crosslink structures) rebond and cure. When this sequence is repeated, the thermoplastic elastomer (composition) of the present invention exhibits recyclability.

The thermoplastic elastomer (composition) of the present invention can be used in, for example, various rubber applications that make the most of its rubber elasticity. Alternatively, use as a hot melt adhesive or as an additive included in hot melt adhesives is advantageous because it can enhance the heat resistance and recyclability thereof. The thermoplastic elastomer (composition) of the present invention can be used even more preferably in automotive and other applications.

Specific examples of automotive applications include tire components such as the tire tread, carcass, sidewall, inner liner, outer tread, and belts; exterior components such as the radiator grille, side molding, garnishes (pillar, rear, cowl-top), aerodynamic parts (air dams, spoilers), wheel covers, weatherstripping, cowbelt grilles, air outlet louvers, air scoops, hood bulges, ventilator parts, protective components (overfenders, side sealing panels, moldings (windows, hood, door belt)), and markings; interior window frame components such as doors, lights, wiper weatherstrip, glass runs, and glass run channels; air duct hoses, radiator hoses, brake lines; lubricating oil system components such as crank shaft seals, valve stem seals, head cover gaskets, automatic transmission oil cooler hoses, transmission oil seals, power steering hoses, and power steering oil seals; fuel system components such as fuel lines, emission control hoses, inlet filler hoses, and diaphragms; vibration damping components such as engine mounts and in-tank pump mounts; boots such as CV joint boots and rack and pinion boots; air conditioning components such as air conditioning hoses and air conditioning seals; belt components such as timing belts and auxiliary belts; and sealers such as windshield sealers, vinyl plastisol sealers, anaerobic sealers, body sealers, and spot weld sealers.

When a rubber modifier is included as an anti-sag agent in a resin or rubber which is subject to cold flow at room temperature, flow at the time of extrusion and cold flow can be prevented.

In addition, the thermoplastic elastomer composition of the present invention which includes the thermoplastic elastomer of the present invention and carbon black and/or silica as well as other ingredients has an improved tensile strength, tear strength and flexural strength, making it particular well-suited for use in such applications as tires, hoses, belts, tubing, sheets, rubber vibration insulators, rollers, linings, rubber-coated fabrics, seals, gloves, side fenders on boats, medical rubber (syringe gaskets, tubing, catheters), gaskets (for electrical appliances and construction), asphalt modifiers, hot melt adhesives, boots, grips, toys, shoes, sandals, key pads, gears, and PET bottle cap liners.

Compared with prior-art thermoplastic elastomers, the thermoplastic elastomer (composition) of the present invention has a better compression set while maintaining about the same degree of recyclability and mechanical properties. Accordingly, even of the above-mentioned applications, it is well-suited for those applications which require in particular a good recyclability and compression set.

### EXAMPLES

The thermoplastic elastomer (composition) of the first and second aspects is illustrated more fully in the examples given below, although the present invention is not limited by these examples.

### Examples 1 to 6, and Comparative Examples 1 to 6

In each example, a liquefied isoprene rubber having a maleic anhydride modification ratio of 2.7 mol % (LIR-410A, produced by Kuraray Co., Ltd.) in an amount of 20 g (maleic anhydride skeleton, 10.29 mmol) was mixed with the respective compounds represented by formula (25) below (Compounds 1 to 12) in an equimolar amount (10.29 mmol) relative to the maleic anhydride introduced onto the main chain. The mixture was placed in a round-bottomed flask and stirred with a mechanical stirrer in an oil bath to effect a reaction under the reaction conditions shown in Table 1 below.

The structures of the thermoplastic elastomers obtained as the reaction products were confirmed by NMR and IR spectroscopy.

The reaction state, viscosity and recyclability of the thermoplastic elastomers of Examples 1 to 6 and Comparative Examples 1 to 6 obtained as described above were evaluated using the methods described below. Those results are presented in Table 1.

TABLE 1

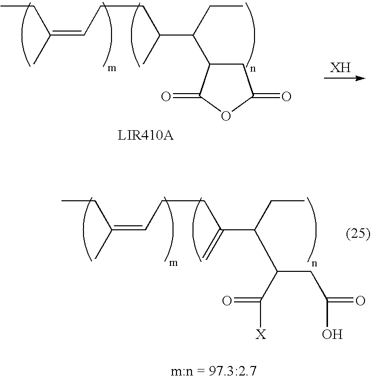

XH =

| 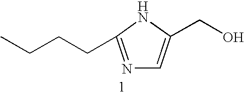 | | 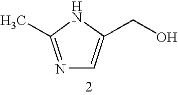 | | | | |
|---|---|---|---|---|---|---|
| 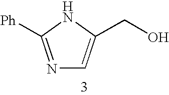 | | 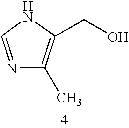 | | | | |
| 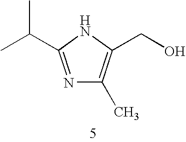 | | 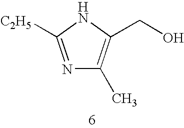 | | | | |
| C₂H₅OH 7 | | 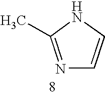 | | | | |
| 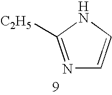 | | 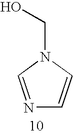 | | | | |
| 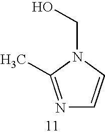 | | 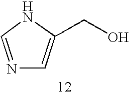 | | | | |
| | | Reaction | Reaction | | Rise in | |
| | Compound | temperature | time | State | viscosity | Recyclability |
| Example 1 | 1 | 180° C. | 1 hour | good | VG | good |
| Example 2 | 2 | 180° C. | 1 hour | good | VG | good |
| Example 3 | 3 | 180° C. | 1 hour | good | VG | good |
| Example 4 | 4 | 180° C. | 1 hour | fair | VG | good |
| Example 5 | 5 | 180° C. | 1 hour | good | VG | good |
| Example 6 | 6 | 180° C. | 1 hour | good | VG | good |
| Comparative Example 1 | 7 | 100° C. | 1 hour | VG | poor | good |
| Comparative Example 2 | 8 | 150° C. | 1 hour | VG | poor | good |
| Comparative Example 3 | 9 | 150° C. | 1 hour | VG | poor | good |
| Comparative Example 4 | 10 | 180° C. | 1 hour | VG | fair | good |
| Comparative Example 5 | 11 | 180° C. | 1 hour | VG | fair | good |
| Comparative Example 6 | 12 | 180° C. | 1 hour | poor | VG | good |

State:

The state during thermoplastic elastomer synthesis (mastication) in Examples 1 to 6 and Comparative Examples 1 to 6 was visually examined and rated as “VG” if mastication was uniform, “good” if mastication was substantially uniform, “fair” if some gelation occurred but mastication was substantially uniform, and “poor” if gelation occurred and mastication was not uniform.

In the present invention, uniform mastification is preferred. A rating of “fair” or better which indicates the absence of a particular problem is desirable for production.

Viscosity:

The change in viscosity before and after thermoplastic elastomer production in Examples 1 to 6 and Comparative Examples 1 to 6 was examined. The viscosity (25° C.) when Compounds 1 to 12 were added to the maleic anhydride-modified isoprene rubber (LIR-4104) and the viscosity (25° C.) after these were reacted were visually evaluated based on the masticated state. The rise in the viscosity of the masticated product after the reaction (thermoplastic elastomer) was rated as follows. The rise in viscosity was rated as “poor” if the thermoplastic elastomer remained liquid (low crosslink density), “fair” if the rise in viscosity was low, “good” if the rise in viscosity was high (high crosslink density), and “VG” if the rise in viscosity was very high. In the present invention, hydrogen bonds form following production, and so it is preferable for the viscosity to rise. A rating of “good” or better is more preferred.

Recyclability:

In each of the above cases, if the above thermoplastic elastomer was confirmed to be flowable when heated at 120° C. for 10 minutes, the recyclability was rated as “good.”

### Examples 7 to 12, and Comparative Examples 7 and 8

A maleic anhydride-modified ethylene-propylene copolymer (EPM) (test product prepared by DSM; ethylene content, 60 mol %; maleic anhydride modification ratio, 0.8 mol %; weight-average molecular weight, 90,000) in an amount of 120 g (maleic anhydride skeleton, 26.9 mmol) or a maleic anhydride-modified ethylene-propylene copolymer (EPM) (TX-1024, produced by Mitsui Chemicals, Inc.; maleic anhydride modification ratio, 1.0 wt %) in an amount of 120 g (maleic anhydride skeleton, 1.22 mmol) was mixed with Compounds 1 to 3 represented by above formula (25) or 3-aminotriazole (produced by Nippon Carbide Industries Co., Inc.) (each being in equimolar amounts relative to the maleic anhydride) and an age resister (Nocrac 6C, produced by Ouchi Shinko Chemical Industry Co., Ltd.) in the number of parts by weight indicated in Table 2 below, following which the components were heated and worked together in a kneader at 170° C. for 30 to 35 minutes.

The structures of the thermoplastic elastomers obtained as the reaction products and the thermoplastic elastomer compositions were confirmed by NMR and IR spectroscopy.

Each of the thermoplastic elastomers and thermoplastic elastomer compositions thus obtained were subjected to hardness measurements and evaluations of the tensile properties, compression set and recyclability using the subsequently described measurement methods. Those results are shown in Table 2 below.

TABLE 2

| | EX 7 | EX 8 | EX 9 | CE 7 | EX 10 | EX 11 | EX 12 | CE 8 |
|---|---|---|---|---|---|---|---|---|
| Maleinized EPM (DSM) | 120 | 120 | 120 | 120 | | | | |
| Maleinized EPM (TX-1024) | | | | | 120 | 120 | 120 | 120 |
| Age resister (6C) | 1.2 | 1.2 | 1.2 | 1.2 | | | | |
| 3-Aminotriazole | | | | 0.75 | | | | 1.08 |
| Compound 1 | 3.0 | | | | 1.44 | | | |
| Compound 2 | | 4.7 | | | | 2.23 | | |
| Compound 3 | | | 4.2 | | | | 1.98 | |
| JIS-A hardness | 55 | 56 | 56 | 54 | 70 | 69 | 68 | 69 |
| M₅₀ (MPa) | 0.87 | 0.88 | 0.98 | 0.8 | 1.72 | 1.74 | 1.74 | 1.51 |
| M₁₀₀ (MPa) | 1.22 | 1.21 | 1.43 | 1.1 | 1.86 | 1.86 | 1.87 | 1.62 |
| M₂₀₀ (MPa) | 1.72 | 1.66 | 2.08 | 1.45 | 2.00 | 1.97 | 1.99 | 1.72 |
| M₃₀₀ (MPa) | 2.28 | 2.17 | 2.74 | 1.79 | 2.28 | 2.22 | 2.24 | 1.89 |
| M₄₀₀ (MPa) | 2.92 | 2.78 | 3.47 | 2.17 | 2.62 | 2.52 | 2.57 | 2.27 |
| T_{B} (MPa) | 3.23 | 3.49 | 3.91 | 2.65 | 3.44 | 3.35 | 3.76 | 2.75 |
| E_{B} (%) | 452 | 544 | 467 | 554 | 718 | 735 | 867 | 754 |
| Compression set (%) | 83 | 89 | 88 | 92 | 86 | 91 | 92 | 94 |
| Recyclability | good | good | good | good | good | good | good | good |

JIS-A Hardness:

The resulting thermoplastic elastomers and thermoplastic elastomer compositions of the present invention were molded under pressure at 200° C. for 10 minutes into flat sample plates having a thickness of 2 cm, a length of 15 cm and a width of 15 cm. Three of the sample plates were stacked together and hot-pressed at 200° C. for 20 minutes, following which the JIS-A hardness was measured in accordance with JIS K6253.

Compression Set (C-Set):

Each of the above thermoplastic elastomers and thermoplastic elastomer compositions was hot-pressed at 200° C. for 10 minutes to form a 2 mm thick sheet, following which seven such sheets were stacked together and hot-pressed at 200° C. for 20 minutes to form a cylindrical sample (diameter, 29 mm; thickness, 12.5 mm).

This cylindrical sample was compressed 25% in a special-purpose jig and held at 70° C. for 22 hours, following which the compression set was measured in accordance with JIS K6262.

Tensile Properties:

Each of the above thermoplastic elastomers and thermoplastic elastomer compositions was hot-pressed at 180° C. for 10 minutes to form a 2 mm thick sheet.

A test piece in the shape of No. 3 dumbbell was stamped from the sheet. A tensile test was carried out at a test rate of 500 mm/min in accordance with JIS K6251 and the 50% modulus M₅₀ (MPa), 100% modulus M₁₀₀ (MPa), 200% modulus M₂₀₀ (MPa), 300% modulus M₃₀₀ (MPa), 400% modulus M₄₀₀ (MPa), tensile strength at break T_{B} (MPa), and elongation at break E_{B} (%) were measured at room temperature.

Recyclability:

Each of the above thermoplastic elastomers and thermoplastic elastomer compositions was hot-pressed at 200° C. for 10 minutes to form a 2 mm thick sheet, following which the sheet was finely chopped and again molded under applied pressure. Evaluation was carried out by determining the number of times that an integral, seamless sheet could be repeatedly manufactured.

A rating of “good” was assigned when the number of times such a sheet could be manufactured was ten or more, and a rating of “fair” was assigned when the number of times such a sheet could be manufactured was at least eight but less than ten.

### Examples 13 to 15, and Comparative Example 9

A maleic anhydride-modified ethylene-propylene copolymer (EPM) (TX-1023, produced by Mitsui Chemicals, Inc.), 120 g, was mixed with Compound 1 of formula (25) above, Compound 5 (2-isopropyl-4-methyl-5-hydroxymethylimidazole), Compound 6 (2-ethyl-4-methyl-5-hydroxymethylimidazole) or 3-aminotriazole (produced by Nippon Carbide Industries Co., Inc.) (each in an equimolar amount relative to the maleic anhydride) in the number of parts by weight indicated in Table 3 below, following which the components were heated and worked together in a kneader at 170° C. for 30 to 35 minutes.

The structures of the thermoplastic elastomers obtained as the reaction products and the thermoplastic elastomer compositions were confirmed by NMR and IR spectroscopy.

Each of the thermoplastic elastomers thus obtained was subjected to hardness measurements and evaluations of the tensile properties, compression set and recyclability using the measurement methods described above. Those results are shown in Table 3 below.

TABLE 3

| | EX 13 | EX 14 | EX 15 | CE 9 |
|---|---|---|---|---|
| Maleinized EPM (TX-1023) | 120 | 120 | 120 | 120 |
| Compound 1 | 2.45 | | | |
| Compound 5 | | 2.45 | | |
| Compound 6 | | | 2.23 | |
| 3-Aminotriazole | | | | 1.34 |
| JIS-A hardness | 74 | 72 | 73 | 74 |
| M₅₀ (MPa) | 1.97 | 1.94 | 1.96 | 1.92 |
| M₁₀₀ (MPa) | 2.18 | 2.13 | 2.16 | 2.12 |
| M₂₀₀ (MPa) | 2.52 | 2.48 | 2.48 | 2.43 |
| M₃₀₀ (MPa) | 3.05 | 3.04 | 3.00 | 2.86 |
| M₄₀₀ (MPa) | 3.81 | 3.83 | 3.70 | 3.38 |
| T_{B} (MPa) | 6.58 | 8.95 | 8.45 | 6.53 |
| E_{B}(%) | 741 | 780 | 856 | 891 |
| Compression set (%) | 80 | 75 | 77 | 87 |
| Recyclability | good | good | good | good |

From above Table 1, the thermoplastic elastomers of Examples 1 to 6 according to the present invention, in spite of having hydrogen atoms on the imidazole rings, were able to suppress gelation. Those thermoplastic elastomers having imidazole rings with an alkyl, aralkyl or aryl group at the 2 position (Examples 1 to 3, 5 and 6) were able to fully suppress gelation. By contrast, the thermoplastic elastomer of Comparative Example 6 which had no alkyl, aralkyl or aryl groups on the imidazole rings underwent gelation. Moreover, the thermoplastic elastomers of Examples 1 to 6 according to the present invention showed very high rises in viscosity, whereas the thermoplastic elastomer of Comparative Example 1 without nitrogen heterocycles had a low rise in viscosity. In Comparative Examples 2 and 3, because the nitrogen heterocycles lacked hydroxyl groups, they did not react with the maleic anhydride introduced onto the main chain, and so a rise in viscosity was not observed. The thermoplastic elastomers in Comparative Examples 4 and 5 which lacked hydrogen atoms on the nitrogen atoms of the imidazole rings had a low rise in viscosity. This result is presumably due to the influence of the hydrogen bonding ratio. The thermoplastic elastomers of Examples 1 to 6 and Comparative Examples 1 to 6 had excellent recyclabilities.

Also, it is clear from Table 2 above that, compared with a thermoplastic elastomer composition (Comparative Example 7) and a thermoplastic elastomer (Comparative Example 8) containing aminotriazole, thermoplastic elastomer compositions (Examples 7 to 9) and thermoplastic elastomers (Examples 10 to 12) containing Compounds 1 to 3 each had a particularly good modulus, tensile strength at break and elongation at break in tensile tests. In addition, each also had an excellent compression set and recyclability, and each had a comparable hardness.

The results in Table 3 show that each of the thermoplastic elastomers in Examples 13 to 15 had a much better modulus, tensile strength at break and elongation at break in tensile tests than did the thermoplastic elastomer in Comparative Example 9. Each also had an excellent compression set and recyclability, and had as well a comparable hardness.

Next, the thermoplastic elastomer (composition) of the third and fourth aspects is illustrated more fully in the examples given below, although the present invention is not limited by these examples.

### Examples 16 to 24, Comparative Example 10, and Reference Examples 1 and 2

Any one or two from among ethanol, butyl hydroxymethylimidazole (BMI, produced by The Nippon Synthetic Chemical Industry Co., Ltd.), 2-isopropyl-4-methyl-5-hydroxymethylimidazole (IMH, produced by The Nippon Synthetic Chemical Industry Co., Ltd.), N-n-butylaminoethanol (MBM, produced by Nippon Nyukazai Co., Ltd.), N-n-dodecylaminoethanol (Nymeen L-201; produced by NOF Corporation) and N-n-octylaminoethanol (Nymeen C-201, produced by NOF Corporation) was added in the number of parts by weight indicated in Table 4 below to 100 g (maleic anhydride skeleton, 10.2 mmol) of a maleic anhydride-modified ethylene-propylene copolymer (TX-1024, produced by Mitsui Chemicals, Inc.; maleic anhydride modification ratio, 1.0 wt %; abbreviated below as “maleinized EPM1”), 110 g (maleic anhydride skeleton, 1.68 mmol) of a maleic anhydride-modified ethylene-propylene copolymer (TX-1023, produced by Mitsui Chemicals, Inc.; maleic anhydride modification ratio, 1.5 wt %; abbreviated below as “maleinized EPM2”) or 100 g (maleic anhydride skeleton, 10.2 mmol) of a maleic anhydride-modified ethylene-acrylic copolymer (AR201, produced by DuPont-Mitsui Polychemicals, Co., Ltd.; maleic anhydride modification ratio, 1.0 wt %; abbreviated below as “maleinized AEM1”), following which the ingredients were worked together in a kneader so as to prepare a reaction product having the target introduction ratio (mol %) and relative introduction ratio.

Specifically, in Examples 16 to 18, Comparative Example 10 and Reference Examples 1 and 2, maleinized EPM1 or maleinized AEM1 was charged into a kneader set at 150° C. and masticated for 3 minutes. Next, ethanol, BMI, MBM or Nymeen L-201 in the amount indicated in Table 4 below was added and kneading was carried out for 10 minutes, following which the rubber was removed from the kneader. Following removal, the rubber was placed once again in the kneader and worked for another 5 minutes, thereby giving the reaction product.

Similarly, in Examples 19 to 24, maleinized EPM1, maleinized EPM2 or maleinized AEM1 was charged into a kneader set at 150° C., and masticated for 3 minutes. Next, BMI or IMH in the amount indicated in Table 4 below was added and kneading was carried out for 7 minutes. MBM, Nymeen L-201 or Nymeen C-201 in the amount indicated in Table 4 below was then added, kneading was carried out for another 5 minutes, and the rubber was removed from the kneader. Following removal, the rubber was placed once again in the kneader and worked for another 5 minutes, thereby giving the reaction product.

The structures of each of the thermoplastic elastomers obtained as the reaction products were confirmed by NMR and IR spectroscopy. In addition, the appearance of each of the thermoplastic elastomers thus obtained was evaluated, the compression set and hardness were measured, and the tensile properties, processability and recyclability were evaluated. The results are shown below in Table 4.

Appearance:

Each of the resulting thermoplastic elastomers was visually examined and checked for the presence or absence of coloration. The absence of coloration is indicated in the table as “clear.” If coloration occurred, the color is indicated.

Compression Set (C-Set):

Compression set for each of the resulting thermoplastic elastomers was measured by the same method as that used in the examples of the thermoplastic elastomer (composition) of the first and second aspect.

JIS-A Hardness:

The JIS-A hardness of each of the resulting thermoplastic elastomers was measured by the same method as that used in the examples of the thermoplastic elastomer (composition) of the first and second aspects.

Tensile Properties:

The tensile properties of each of the resulting thermoplastic elastomers were measured by the same methods as those used in the examples of the thermoplastic elastomer (composition) of the first and second aspect. The thermoplastic elastomer obtained in Example 16 had an elongation at break of 233%, so no data is indicated for M₃₀₀ and M₄₀₀. The thermoplastic elastomer obtained in Example 19 had an elongation at break of 353%, so no data is indicated for M₄₀₀.

Processability:

The processability was checked for suitability by visually examining the degree to which each of the resulting thermoplastic elastomers held together just after it was removed from the kneader. The processability was rated as “poor” if the thermoplastic elastomer did not hold together well and was thus unsuitable for processing, “good” if the elastomer held together well enough for processing, and “VG” if it held together very well and was thus even more suitable for processing.

Recyclability:

The recyclability of each of the resulting thermoplastic elastomers was evaluated by the same method as that used in the examples of the thermoplastic elastomer (composition) of the first and second aspect.

TABLE 4

| | CE 10 | RE 1 | RE 2 | EX 16 | EX 17 | EX 18 |
|---|---|---|---|---|---|---|
| Maleinized EPM1 | 100 | 100 | | 100 | 100 | |
| Maleinized EPM2 | | | | | | |
| Maleinized AEM1 | | | 100 | | | 100 |
| Ethanol | 0.47 | | | | | |
| BMI | | 1.58 | 1.58 | | | |
| IMH | | | | | | |
| MBM | | | | 1.19 | | |
| Nymeen L-201 | | | | | 2.43 | 2.43 |
| Nymeen C-201 | | | | | | |
| Relative introduction ratio | — | — | — | — | — | — |
| Appearance | clear | brown | brown | clear | clear | clear |
| Compression set (%) | 100 | 82 | 93 | 22 | 61 | 48 |
| JIS-A hardness | 50 | 66 | 57 | 69 | 67 | 53 |
| Tensile properties | | | | | | |
| M₅₀ (MPa) | 0.1 | 1.85 | 1.18 | 1.87 | 1.55 | 0.96 |
| M₁₀₀ (MPa) | 0.2 | 1.94 | 1.52 | 2.55 | 1.74 | 1.25 |
| M₂₀₀ (MPa) | 0.3 | 2.06 | 1.84 | 3.69 | 2.05 | 1.56 |
| M₃₀₀ (MPa) | 0.3 | 2.30 | 2.03 | — | 2.49 | 1.75 |
| M₄₀₀ (MPa) | 0.3 | 2.61 | 2.16 | — | 3.00 | 1.90 |
| T_{B} (MPa) | 0.4 | 3.61 | 2.61 | 4.44 | 3.52 | 3.75 |
| E_{B}(%) | >1000 | 758 | 818 | 233 | 494 | 1083 |
| Processability | VG | VG | VG | poor | good | good |
| Recyclability | good | good | good | good | good | good |

| | Example 19 | Example 20 | Example 21 | Example 22 | Example 23 | Example 24 |
|---|---|---|---|---|---|---|
| Maleinized EPM1 | 100 | 100 | | | | |
| Maleinized EPM2 | | | | | | 110 |
| Maleinized AEM1 | | | 100 | 100 | 100 | |
| Ethanol | | | | | | |
| BMI | 0.39 | 0.78 | 0.39 | 0.39 | 1.18 | |
| IMH | | | | | | 2.16 |
| MBM | 0.90 | 0.60 | 0.90 | | 0.30 | |
| Nymeen L-201 | | | | 1.82 | | |
| Nymeen C-201 | | | | | | 0.61 |
| Relative introduction ratio | 2.5/7.5 | 1/1 | 2.5/7.5 | 2.5/7.5 | 8.5/1.5 | 8/2 |
| Appearance | pale brown | pale brown | pale brown | pale brown | pale brown | pale brown |
| Compression set (%) | 28 | 61 | 57 | 81 | 88 | 48 |
| JIS-A hardness | 70 | 69 | 54 | 56 | 55 | 74 |
| Tensile properties | | | | | | |
| M₅₀ (MPa) | 1.67 | 1.61 | 1.18 | 1.04 | 1.16 | 1.91 |
| M₁₀₀ (MPa) | 1.95 | 1.78 | 1.49 | 1.30 | 1.45 | 2.17 |
| M₂₀₀ (MPa) | 2.67 | 2.06 | 1.69 | 1.58 | 1.75 | 2.78 |
| M₃₀₀ (MPa) | 3.85 | 2.51 | 2.21 | 1.78 | 1.98 | 3.65 |
| M₄₀₀ (MPa) | — | 3.09 | 2.54 | 1.92 | 2.23 | 4.85 |
| T_{B} (MPa) | 4.49 | 4.99 | 4.65 | 4.26 | 4.77 | 12.17 |
| E_{B}(%) | 353 | 595 | 703 | 1029 | 865 | 680 |
| Processability | good | good | good | VG | VG | VG |
| Recyclability | good | good | good | good | good | good |

As is apparent from Table 4 above, the thermoplastic elastomers obtained in Examples 16 to 24 maintained a better recyclability than thermoplastic elastomers which did not include the structure of above formula (7) on side chains (Comparative Example 10, Reference Examples 1 and 2), and also had an excellent mechanical strength, especially compression set. Moreover, compared with Reference Examples 1 and 2, coloration was suppressed, resulting in an excellent appearance.

### INDUSTRIAL APPLICABILITY

As explained above, the present invention is beneficial because it can provide thermoplastic elastomers which retain an excellent recyclability and yet have an outstanding mechanical strength, especially compression set. Compositions containing these thermoplastic elastomers also exhibit similar highly desirable effects, and are thus also extremely beneficial.

1. A thermoplastic elastomer consists of an elastomeric polymer having, on side chains, carbonyl-containing groups and imidazole rings, which rings bear a hydrogen atom on a nitrogen atom and also bear an alkyl, aralkyl or aryl group.

2. The thermoplastic elastomer according to claim 1, wherein the side chains have a structure of formula (1) or (2) below 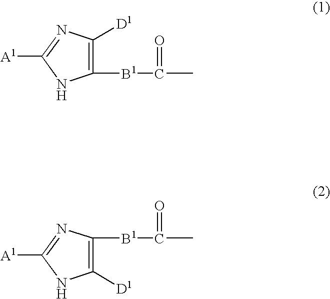
(wherein A¹ is an alkyl group of 1 to 20 carbons, an aralkyl group of 7 to 20 carbons or an aryl group of 6 to 20 carbons; B¹ is a single bond, an oxygen, nitrogen or sulfur atom, or an organic group which may include these atoms; and D¹ is a hydrogen atom, an alkyl group of 1 to 20 carbons, an aralkyl group of 7 to 20 carbons, or an aryl group of 6 to 20 carbons).

3. The thermoplastic elastomer according to claim 1 or 2, wherein the side chains have a structure of any one of formulas (3) to (6) below which is bonded to a main chain at α or β position. 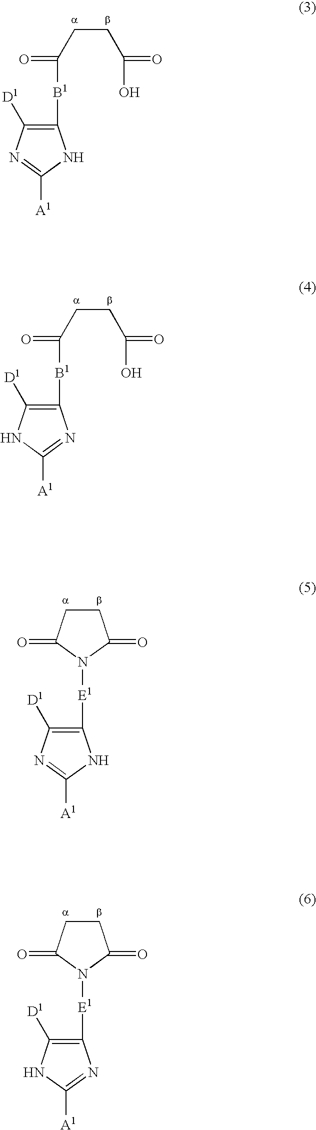
(wherein A¹ is an alkyl group of 1 to 20 carbons, an aralkyl group of 7 to 20 carbons or an aryl group of 6 to 20 carbons; B¹ and E¹ are each independently a single bond, an oxygen, nitrogen or sulfur atom, or an organic group which may include these atoms; and D¹ is a hydrogen atom, an alkyl group of 1 to 20 carbons, an aralkyl group of 7 to 20 carbons or an aryl group of 6 to 20 carbons).

4. A thermoplastic elastomer having side chains which contain a structure of formula (7) below 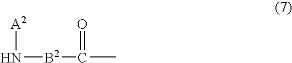
(wherein A² is an alkyl group of 1 to 30 carbons, an aralkyl group of 7 to 20 carbons or an aryl group of 6 to 20 carbons; and B² is a single bond, an oxygen atom, an amino group NR′ (R′ being a hydrogen atom or an alkyl group of 1 to 10 carbons), a sulfur atom, or an organic group which may include these atoms or group).

5. The thermoplastic elastomer according to claim 4, wherein the side chains which include the structure of formula (7) have a structure of formula (8) or (9) below which bonds to a main chain at α or β position 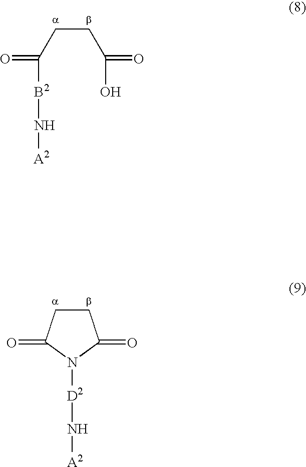
(wherein A² is an alkyl group of 1 to 30 carbons, an aralkyl group of 7 to 20 carbons, or an aryl group of 6 to 20 carbons; B² and D² are each independently a single bond, an oxygen atom, an amino group NR′ (R′ being a hydrogen atom or an alkyl group of 1 to 10 carbons), a sulfur atom, or an organic group which may include these atoms or group).

6. The thermoplastic elastomer according to claim 4 or 5 which also has a nitrogen heterocycle-containing side chains.

7. The thermoplastic elastomer of claim 6, wherein the nitrogen heterocycle-containing side chains include a structure of formula (10) below 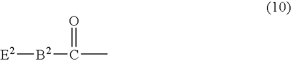
(wherein E² is a nitrogen heterocycle; and B² is a single bond, an oxygen atom, an amino group NR′ (R′ being a hydrogen atom or an alkyl group of 1 to 10 carbons), a sulfur atom, or an organic group which may include these atoms or group).

8. The thermoplastic elastomer according to claim 7, wherein the nitrogen heterocycle-containing side chains have a structure of formula (11) or (12) below which bonds to a main chain at α or β position 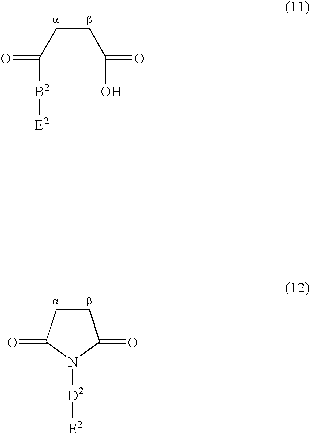
(wherein E² is a nitrogen heterocycle; and B² and D² are each independently a single bond, an oxygen atom, an amino group NR′ (R′ being a hydrogen atom or an alkyl group of 1 to 10 carbons), a sulfur atom, or an organic group which may include these atoms or group).

9. The thermoplastic elastomer according to any one of claims 6 to 8, wherein the nitrogen heterocycle is a five- or six-membered ring.

10. The thermoplastic elastomer according to claim 9, wherein the nitrogen heterocycle is a triazole ring, a thiadiazole ring, a pyridine ring or an imidazole ring.

11. The thermoplastic elastomer according to claim 7, wherein the nitrogen heterocycle-containing side chains have a structure of formula (13), (14) or (15) below 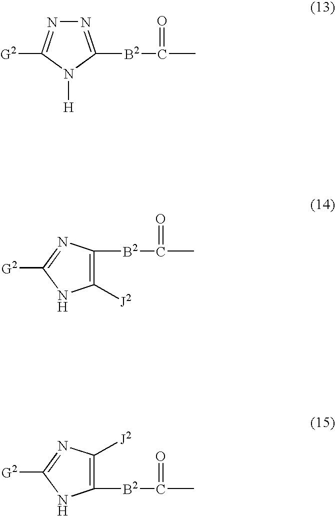
(wherein B² is a single bond, an oxygen atom, an amino group NR′ (R′ being a hydrogen atom or an alkyl group of 1 to 10 carbons), a sulfur atom, or an organic group which may include these atoms or group; and G² and J² are each independently a hydrogen atom, an alkyl group of 1 to 30 carbons, an aralkyl group of 7 to 20 carbons, or an aryl group of 6 to 20 carbons).

12. The thermoplastic elastomer according to claim 11, wherein the nitrogen heterocycle-containing side chains have a structure of formula (16) or (17) or any one of formulas (18) to (21) below which bonds to a main chain at α or β position 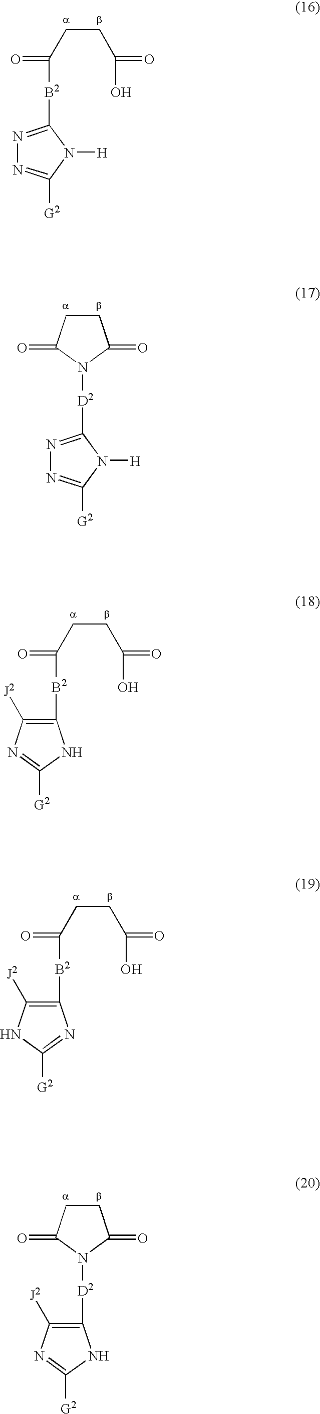 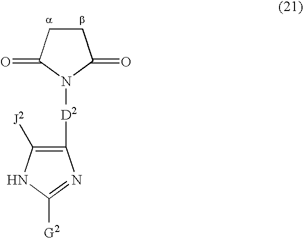
(wherein B² and D² are each independently a single bond, an oxygen atom, an amino group NR′ (R′ being a hydrogen atom or an alkyl group of 1 to 10 carbons), a sulfur atom, or an organic group which may include these atoms or group; and G² and J² are each independently a hydrogen atom, an alkyl group of 1 to 30 carbons, an aralkyl group of 7 to 20 carbons, or an aryl group of 6 to 20 carbons).

13. A method of preparing the thermoplastic elastomer according to any one of claims 4 to 12, which method includes a reaction step in which a compound capable of introducing an imino group is reacted with an elastomeric polymer having cyclic acid anhydride groups on side chains.

14. The method of preparing the thermoplastic elastomer according to claim 13 which additionally includes a reaction step in which a compound capable of introducing a nitrogen heterocycle is reacted.

15. A thermoplastic elastomer composition which includes the thermoplastic elastomer according to any one of claims 1 to 12.

16. The thermoplastic elastomer composition according to claim 15 which additionally includes from 1 to 200 parts by weight of carbon black and/or silica per 100 parts by weight of the thermoplastic elastomer.
